(19) United States
(12) Patent Application Publication
(10) Pub. No.: US 2025/0272551 A1
(43) Pub. Date: Aug. 28, 2025

(54) ACTIVATION-BASED QUANTIZATION OF MACHINE LEARNING MODEL PARAMETERS

(71) Applicants: Rob Knoops, Eindhoven (NL); Arash Pourtaherian, Waalre (NL)

(72) Inventors: Rob Knoops, Eindhoven (NL); Arash Pourtaherian, Waalre (NL)

(21) Appl. No.: 18/587,614

(22) Filed: Feb. 26, 2024

(51) Int. Cl. G06N 3/0495

(52) U.S. Cl. CPC G06N 3/0495

(57) ABSTRACT

Examples described herein relate to quantization of machine learning model parameters. A set of candidate quantization configurations is identified for a component of a trained machine learning model. Each candidate quantization configuration is applied to the component. The trained machine learning model is executed on an input dataset to obtain candidate output values for each candidate quantization configuration. A loss is determined for each candidate quantization configuration based on a comparison between the candidate output values for the candidate quantization configuration and reference output values for the component. One of the candidate quantization configurations is selected for the component based on the determined losses associated with the set of candidate quantization configurations. At least part of the trained machine learning model is quantized using the selected candidate quantization configuration for the component.

### TECHNICAL FIELD

The subject matter disclosed herein relates, generally, to machine learning. More specifically, but not exclusively, the subject matter relates to the quantization of machine learning model parameters.

### BACKGROUND

Quantization is a technique that can be used to reduce the precision of the numerical representation of parameters of a machine learning model, such as the weights in a neural network. For example, by converting weights from floating-point representations (e.g., 32-bit floats) to lower-precision formats (e.g., 8-bit integers), quantization reduces the memory footprint and computational requirements associated with a machine learning model. This can make the machine learning model more efficient for deployment on resource-constrained environments, such as mobile devices, embedded systems, edge devices, or wearable devices (e.g., extended reality (XR) devices). However, quantization also has certain drawbacks, such as the potential loss of model accuracy and reduced inference performance.

### BRIEF DESCRIPTION OF THE SEVERAL VIEWS OF THE DRAWINGS

In the drawings, which are not necessarily drawn to scale, like numerals may describe similar components in different views. To easily identify the discussion of any particular element or act, the most significant digit or digits in a reference number refer to the figure number in which that element is first introduced. Some non-limiting examples are illustrated in the figures of the accompanying drawings in which:

FIG. 1 is a diagrammatic representation of a networked environment in which the present disclosure may be deployed, according to some examples.

FIG. 2 is a block diagram illustrating certain components of a model quantization system, according to some examples.

FIG. 3 is a flowchart illustrating operations of a method suitable for selecting one or more quantization configurations for a trained machine learning model, according to some examples.

FIG. 4 diagrammatically illustrates a quantization pipeline, according to some examples.

FIG. 5 is a Unified Modeling Language (UML) diagram that outlines the structure and relationships of an “activation-aware quantization class” and associated functions, according to some examples.

FIG. 6 diagrammatically illustrates a processing system, according to some examples.

FIG. 7 diagrammatically illustrates an XR device, according to some examples.

FIG. 8 diagrammatically illustrates a machine learning pipeline, according to some examples.

FIG. 9 diagrammatically illustrates training and use of a machine learning program, according to some examples.

FIG. 10 is a diagrammatic representation of a machine in the form of a computer system within which a set of instructions may be executed to cause the machine to perform any one or more of the methodologies discussed herein, according to some examples.

FIG. 11 is a block diagram showing a software architecture within which examples may be implemented.

### DETAILED DESCRIPTION

The quantization of parameters of a machine learning model may be performed in various scenarios. For example, when deploying a machine learning model to hardware with limited resources, such as limited memory or battery resources, its parameters may be quantized prior to deployment to reduce the memory footprint and/or computational requirements of the machine learning model. This can be the case, for example, in edge devices or wearable devices where parameters need to be stored in limited on-chip memory to provide satisfactory inference performance.

For example, in a typical machine learning model, (unquantized) parameters developed during training can be represented using 32-bit floating-point numbers. Quantization may then involve converting these numbers into lower-precision formats, such as 16-bit floating-point numbers, 8-bit integers, or even lower (e.g., into 4-bit or 6-bit formats), for storage. This conversion reduces the overall size of the machine learning model and the amount of memory resources and/or computation needed for inference.

Converting parameters of a machine learning model to lower-precision representations can lead to a decrease in the fidelity of the parameters, which may negatively affect the performance of the machine learning model (e.g., it can degrade the ability of the machine learning model to capture or accurately identify subtle patterns in data during inference). Accordingly, it may be desirable to select optimal or near-optimal quantization configurations (e.g., bit settings) within the context and limitations of the relevant machine learning model, hardware, and inference use case.

For example, when a weight tensor is to be quantized to 8 bits, the bit settings for exponent and mantissa bits (e, m) can take different combinations of values, such as (0, 7), (2, 5), (3, 4), or (4, 3) (each totaling 7 bits in addition to a single, fixed sign bit). It may be technically challenging to select a combination that will have a minimal adverse impact on the performance or accuracy of the machine learning model when compared to its performance or accuracy when run with unquantized parameters.

Examples described herein utilize a relatively small amount of input data (e.g., a small batch of samples) to ensure that quantization configurations can be allocated in an effective manner, resulting in higher accuracy when machine learning models are ultimately deployed on the relevant hardware. Examples described herein allow for the automatic assessment of loss associated with a given quantization configuration, as applied to machine learning model parameters, with reference to outputs generated using that quantization configuration (e.g., feature map values or activations) as opposed to assessing loss with reference to the parameters (e.g., weights) themselves. In other words, instead of selecting, for example, bit settings based on errors introduced on parameter values compared to their original values, examples described herein base such selections on errors or deviations in intermediate outputs generated within a machine learning model. Accordingly, examples described herein leverage “activation-based” or “activation-aware” quantization.

In some examples of the present disclosure, various candidate quantization configurations (e.g., different possible bit settings) are automatically evaluated to select one or more optimal or near-optimal candidate quantization configurations. Such evaluation and selection may be performed for each of a plurality of components of a machine learning model (e.g., layers or channels within a neural network). Examples described herein allow for the automatic selection of a suitable number of exponent bits and mantissa bits, for the weights of a given component of a neural network, that minimizes loss compared to reference outputs while accommodating a selected bit precision.

An example method includes identifying a set of candidate quantization configurations for a component of a trained machine learning model. The term “quantization configuration,” as used herein, refers to one or more rules, parameters, or settings that govern or determine how a quantization process should be carried out for a machine learning model or one or more particular components thereof. For example, a quantization configuration can indicate the number of bits to which parameters of a machine learning model will be reduced (e.g., precision level), the allocation of these bits among various aspects of the parameters (such as exponent and mantissa in floating-point representation), a quantization scheme or algorithm, quantization granularity (e.g., per-layer or per-channel configurations), and/or the method by which values are rounded or truncated to fit within specified constraints.

The candidate quantization configurations identified by a system as described herein can, for example, comprise different possible bit settings for a component. The term “component,” as used herein in the context of a machine learning model, refers to a part, region, or substructure within the machine learning model that performs one or more specific functions or represents one or more particular aspects of a model architecture. Components can, for example, include layers in a neural network (such as convolutional layers, fully-connected layers, or activation layers), nodes, or neurons within those layers. For example, in a convolutional neural network used for image recognition, a component can comprise a convolutional layer that detects edges or textures within the input images. A component may also be a sub-element of a layer, such as a channel.

The method may include, for each candidate quantization configuration in the set of candidate quantization configurations, applying the candidate quantization configuration to the component, and, after applying the candidate quantization configuration, executing the trained machine learning model on an input dataset (e.g., a small set of input samples) to obtain candidate output values for the candidate quantization configuration. The input dataset may comprise unlabeled sample data. In the context of image processing, the input dataset may include unlabeled sample images. In some examples, the input dataset is a relatively small sample, such as less than 100 images, less than 50 images, or even less than 40 images. Accordingly, examples described herein enable evaluation of candidate quantization configurations without requiring processing of large datasets.

In some examples, the input dataset includes data representative of data that the trained machine learning model is expected to process during inference. For example, where the machine learning model was trained to identify different breeds of cats in images, the input dataset can include images of cats.

The method may further include determining a loss associated with the candidate quantization configuration based on a comparison between the candidate output values and reference output values for the component. Application of the candidate quantization configuration to the component may cause the trained machine learning model to be executed with the component having quantized parameters to obtain the candidate output values, while the reference output values are obtained by executing the trained machine learning model with the component having unquantized parameters (e.g., original parameters prior to initiating quantization). In this way, candidate output values associated with quantized parameters can be compared against reference output values associated with unquantized parameters. In this context, the “parameters” may be internal variables that are learned, adjusted, or refined from training data. For instance, in a neural network, the parameters comprise weights that connect neurons across different layers or biases that adjust the activation level of each neuron. Techniques described herein relate to the transformation or conversion of unquantized versions of such parameters to quantized versions thereof.

The term “output,” in the context of comparing “candidate” values to “reference” values, refers to data generated as a result of processing by the component within the trained machine learning model. Such “outputs” are intermediate outputs within the machine learning model, as opposed to “final” outputs (e.g., a final inference result). Output values may include feature map values or activations within a machine learning model. Output values may also refer to values to which a threshold function has been applied.

The method may further include selecting, for the component of the trained machine learning model, a candidate quantization configuration from the set of candidate quantization configurations based on the determined losses associated with the set of candidate quantization configurations. For example, the loss associated with a particular candidate quantization configuration can be determined based on a loss function such that selection of the candidate quantization configuration from the set of candidate quantization configurations comprises detecting that the selected candidate quantization configuration results in a lowest value for the loss function with respect to the component of the trained machine learning model.

For example, a loss function compares a matrix of values produced by a neural network layer using quantized weights to a matrix of values produced by the same neural network layer using unquantized weights to determine how or to what extent quantization has “deformed” the outputs (as compared to the original or baseline outputs). Examples of loss functions include L1 Loss (also known as Mean Absolute Error or MAE) and L2 Loss (also known as Mean Squared Error or MSE), as described in greater detail elsewhere. However, loss may be determined in various ways since errors or discrepancies between outputs (e.g., reference values and candidate values) can be calculated using various techniques.

In some examples, at least part of the trained machine learning model is quantized using the selected candidate quantization configuration for the component. Quantization of the trained machine learning model may include quantizing parameters thereof. Accordingly, examples described herein relate specifically to post-training quantization involving quantization of parameters after a model has been trained.

The above description refers to the selection of a quantization configuration for a single component of a trained machine learning model. However, it will be appreciated that a similar approach may be adopted to select a quantization configuration for multiple components or even an entire machine learning model. In some examples, the method is performed such that different quantization configurations may be selected for different components. Accordingly, the trained machine learning model may ultimately be quantized using one quantization configuration for one or more components and one or more further quantization configurations for one or more further components.

In some examples, the method includes determining a first quantization configuration that comprises first bit settings for quantizing parameters of a first layer of a neural network, a second quantization configuration that comprises second bit settings for quantizing parameters of a second layer of the neural network, and so forth. Bit settings for different layers may be the same or different, depending on the outcome of candidate output value evaluations.

An example system accounts for threshold functions within a trained machine learning model. For example, where an evaluated component comprises a layer of a neural network that is associated with a threshold function, the threshold function may be applied to obtain at least a subset of the candidate output values and at least a subset of the reference output values. In other words, the system may evaluate outputs as adjusted after application of a threshold function or another function that is, for example, designed to introduce non-linearity in outputs.

As mentioned, the parameters to be quantized may comprise weights. Each weight may be quantized to be represented by a combination of exponent bits and mantissa bits. In some cases, the number of exponent bits or the number of mantissa bits is zero. Accordingly, as used herein, the phrase “combination of exponent bits and mantissa bits” may include combinations in which the number of exponent bits or the number of mantissa bits is zero. For example, where 7 bits are available for exponent and mantissa bits, the combination (0, 7) is still a “combination of exponent bits and mantissa bits” even though the value for the number of exponent bits is zero.

The method may include receiving, from a user device, a quantization request comprising a selected bit precision for quantization of the component. The set of candidate quantization configurations may then be identified based on the selected bit precision, with the set of candidate quantization configurations comprising different combinations of exponent bits and mantissa bits that satisfy the selected bit precision.

The quantization of the trained machine learning model may comprise generating a new instance of the trained machine learning model that comprises the selected candidate quantization configuration for the component. In some examples, the new instance is generated (and, in some examples, returned) in response to receiving a quantization request from a user device. The quantization request may include input parameters, such as the selected bit precision.

In some examples, the method includes storing the quantized parameters in on-chip memory of a processing device. For example, a processing device can have on-chip static random access memory (SRAM) in which the quantized parameters are stored. On-chip storage of parameters that were quantized using techniques described herein may present several benefits. For example, on-chip storage can lead to quicker retrieval of model parameters during inference, greater energy efficiency, and/or lower latency. Techniques described herein can make it feasible or possible to fit model parameters within the limited space of on-chip memory, while balancing memory savings with model accuracy.

The method may include performing batch normalization folding prior to the quantizing of the trained machine learning model. For example, prior to obtaining the candidate output values and the reference output values for evaluation, the system can automatically perform batch normalization folding.

In some examples, the method includes generating output comprising the selected candidate quantization configuration, and causing the output to be transmitted to a user device. In this way, quantization configurations determined to be optimal or near-optimal can be transmitted for downstream use.

Techniques described herein may be implemented in or beneficial to different types of processing systems. In some examples, the trained machine learning model is quantized for deployment on an event-based neural processor that has a plurality of processing clusters. In some examples, the trained machine learning model is quantized for deployment on a computing device, such as an XR device or other wearable device, that includes such an event-based neural processor. An XR device may be an augmented reality (AR) or virtual reality (VR) device. Accordingly, quantization may be performed to allow the trained machine learning model to be deployed to a device with memory constraints or a device designed for low power consumption.

According to some examples, the presently described systems or methodologies provide an improvement in the functioning of a computing device by providing an improved technique for selecting and applying quantization configurations. Computing resources may be saved or more efficiently utilized as a result of implementation of these methodologies. Examples of such computing resources include processor cycles, network traffic, memory usage, data storage capacity, power consumption, network bandwidth, and cooling capacity.

Examples described herein can further provide technical solutions to technical problems. For example, one technical problem with current machine learning model deployment can be that significant computational resources are required to operate large, complex models, particularly in resource-constrained environments such as mobile devices, wearable devices, or edge computing platforms. These models, often configured with high-precision parameters, can be relatively demanding in terms of memory and processing power, leading to inefficiencies and practical limitations on their use. Examples described herein provide a technical solution to this problem through systematic selection of an optimal or near-optimal quantization configuration for each of one or more components of the model. By doing so, parameter precision may be reduced in a controlled and/or selective manner, decreasing model size and computational requirements without a substantial or unacceptable loss in accuracy, thus enabling efficient deployment on hardware with limited resources.

A further technical problem can relate to a focus on minimizing the error in parameter values without sufficiently considering the impact on model output, which can lead to suboptimal performance, especially in deep learning models where certain functions introduce non-linearities. Examples described herein address or alleviate this technical problem via an “activation-aware” approach where a quantization process is guided by the loss associated with the feature map values (e.g., activations of a neural network). This approach may be specifically designed to take non-linearities into account when comparing candidate and reference outputs. This may ensure that quantization substantially preserves the functional behavior of a model, maintaining sound predictive performance even after parameter precision reduction. By focusing on activations, examples described herein provide a technical solution that aligns a quantization process more closely to the operational characteristics of a model.

Other technical problems can relate to technical difficulties in automating a quantization process, while allowing for user input or interaction where desired. A quantization pipeline can be complex and time-consuming, requiring expertise in both machine learning and hardware optimization. Examples described herein automate various aspects of the quantization pipeline and provide user interaction components that make it easy for users to specify preferences and objectives or monitor progress. For example, a user-friendly interface can be provided to guide the selection of quantization configurations based on user-defined criteria.

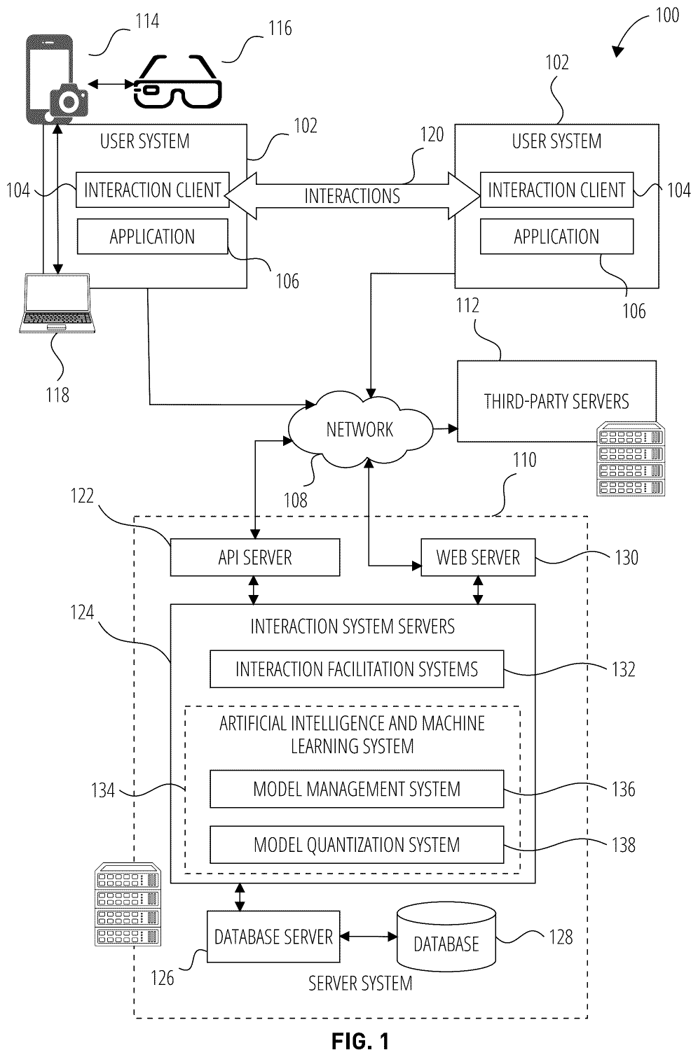

FIG. 1 is a block diagram showing an example interaction system 100 for facilitating interactions (e.g., exchanging text messages, conducting text, audio and video calls, or playing games) over a network. The interaction system 100 includes multiple user systems 102, each of which hosts multiple applications, including an interaction client 104 (as an example of an interaction application) and other applications 106. Each interaction client 104 is communicatively coupled, via one or more communication networks including a network 108 (e.g., the Internet), to other instances of the interaction client 104 (e.g., hosted on respective other user systems 102), a server system 110, and third-party servers 112. An interaction client 104 can also communicate with locally hosted applications 106 using Application Programming Interfaces (APIs).

Each user system 102 may include one or multiple user devices, such as a mobile device 114, head-wearable apparatus 116, and a computer client device 118, that are communicatively connected to exchange data and messages.

An interaction client 104 interacts with other interaction clients 104 and with the server system 110 via the network 108. The data exchanged between the interaction clients 104 (e.g., interactions 120) and between the interaction clients 104 and the server system 110 include functions (e.g., commands to invoke functions) and payload data (e.g., text, audio, video, or other multimedia data).

The server system 110 provides server-side functionality via the network 108 to the interaction clients 104. While certain functions of the interaction system 100 are described herein as being performed by either an interaction client 104 or by the server system 110, the location of certain functionality either within the interaction client 104 or the server system 110 may be a design choice. For example, it can be technically preferable to deploy particular technology and functionality within the server system 110 initially, but later migrate this technology and functionality to the interaction client 104 where a user system 102 has sufficient processing capacity.

The server system 110 supports various services and operations that are provided to the interaction clients 104. Such operations include transmitting data to, receiving data from, and processing data generated by the interaction clients 104. This data may include message content, device information, geolocation information, content augmentation (e.g., filters or overlays), message content persistence conditions, entity relationship information, machine learning model data, and live event information. Data exchanges within the interaction system 100 may be invoked and controlled through functions available via user interfaces of the interaction clients 104.

Turning now specifically to the server system 110, an API server 122 is coupled to and provides programmatic interfaces to interaction system servers 124, making the functions of the interaction system servers 124 accessible to interaction clients 104, other applications 106 and third-party servers 112. The interaction system servers 124 are communicatively coupled to a database server 126, facilitating access to a database 128 that stores data associated with interactions processed and other functions performed by the interaction system servers 124. Similarly, a web server 130 is coupled to the interaction system servers 124 and provides web-based interfaces to the interaction system servers 124. To this end, the web server 130 processes incoming network requests over the Hypertext Transfer Protocol (HTTP) and several other related protocols.

The API server 122 receives and transmits interaction data (e.g., commands and message payloads) between the interaction system servers 124 and the user systems 102 (and, for example, interaction clients 104 and other applications 106) and the third-party servers 112. Specifically, the API server 122 provides a set of interfaces (e.g., routines and protocols) that can be called or queried by the interaction client 104 and other applications 106 to invoke functionality of the interaction system servers 124. The API server 122 exposes various functions supported by the interaction system servers 124, including account registration; login functionality; the sending of interaction data, via the interaction system servers 124, from a particular interaction client 104 to another interaction client 104; the communication of media files (e.g., images or video) from an interaction client 104 to the interaction system servers 124; the settings of a collection of media data (e.g., a story); the retrieval of a list of friends of a user of a user system 102; the retrieval of messages and content; the addition and deletion of entities (e.g., friends) to an entity relationship graph; the location of friends within an entity relationship graph; opening an application event (e.g., relating to the interaction client 104); and the leveraging of artificial intelligence and machine learning functionality.

The interaction system servers 124 host multiple systems and subsystems. For example, the interaction system servers 124 provide multiple interaction facilitation systems 132 that may include an image processing system, an augmentation system, an augmentation creation system, a communication system, and/or a user management system, for example. An image processing system may provide various functions that enable a user to capture and augment (e.g., annotate, or otherwise modify or edit) media content. The augmentation system may provide functions related to the generation and publishing of augmentations (e.g., filters or media overlays), also referred to as augmented reality (AR) effects, for images or videos captured in real-time by cameras of the user system 102 or retrieved from memory of the user system 102.

The augmentation creation system may support AR developer platforms and includes an application for content creators (e.g., artists and developers) to create and publish augmentations (e.g., AR experiences) of the interaction client 104. The augmentation creation system may provide a library of built-in features and tools for content creators including, for example, custom shaders, tracking technology, and templates.

The communication system may be responsible for enabling and processing multiple forms of communication and interaction within the interaction system 100 and can include a messaging system, an audio communication system, and/or a video communication system. The user management system may be operationally responsible for the management of user data and profiles, and maintaining of entity information (e.g., stored in entity tables or entity graphs) regarding users and relationships between users of the interaction system 100.

The interaction system servers 124 further provide an artificial intelligence and machine learning system 134. The artificial intelligence and machine learning system 134 provides a variety of services to different subsystems within the interaction system 100, including one or more of the interaction facilitation systems 132. For example, the artificial intelligence and machine learning system 134 operates with the interaction facilitation systems 132 to analyze images and extract information such as objects, text, or faces. This information can then be used to enhance, filter, or manipulate (e.g., apply an AR effect to) images. As another example, the artificial intelligence and machine learning system 134 can be used to perform object tracking or detection (e.g., gesture recognition) to facilitate operation of a user system 102 in the form of a head-wearable apparatus 116.

The artificial intelligence and machine learning system 134 may be used by the interaction facilitation systems 132 to generate augmented content and AR experiences, such as adding virtual objects or animations to real-world images. The communication system of the interaction facilitation systems 132 may use the artificial intelligence and machine learning system 134 to analyze communication patterns and provide insights into how users interact with each other and provide intelligent message classification and tagging, such as categorizing messages based on sentiment or topic. The artificial intelligence and machine learning system 134 may also provide chatbot functionality to interactions 120 between user systems 102 and between a user system 102 and the interaction server system 110. The artificial intelligence and machine learning system 134 may provide various generative functionalities (e.g., allowing a user to generate text, image, or video content based on prompts). The artificial intelligence and machine learning system 134 may work with the communication system of the interaction facilitation systems 132 to provide speech recognition and natural language processing capabilities.

In some examples, the artificial intelligence and machine learning system 134 is used for machine learning model training, as well as the deployment and management of machine learning models. To this end, the artificial intelligence and machine learning system 134 includes a model management system 136 and a model quantization system 138.

The model management system 136 serves as a hub within the server system 110 for overseeing the lifecycle of various machine learning models. The model management system 136 may be responsible for the storage, versioning, distribution, and/or monitoring of models. The model management system 136 may communicate with the model quantization system 138 to receive processed models that have undergone a quantization process. The model management system 136 may be designed to ensure that the most up-to-date and efficient versions of models are readily available for deployment. The model management system 136 may also be responsible for testing, for example, to compare the performance of different model iterations or instances.

The machine learning models may be used in the context of the interaction clients 104 or more generally by user systems 102. In some examples, upon successful quantization and validation, the model management system 136 coordinates with interaction clients 104 running on user systems 102 to deploy quantized models for inference tasks. Models may be accessed via the network 108 or run on the user systems 102. The model management system 136 may send updates to the interaction clients 104, which may be part of various applications such as image recognition, natural language processing, or other artificial intelligence-driven functionalities.

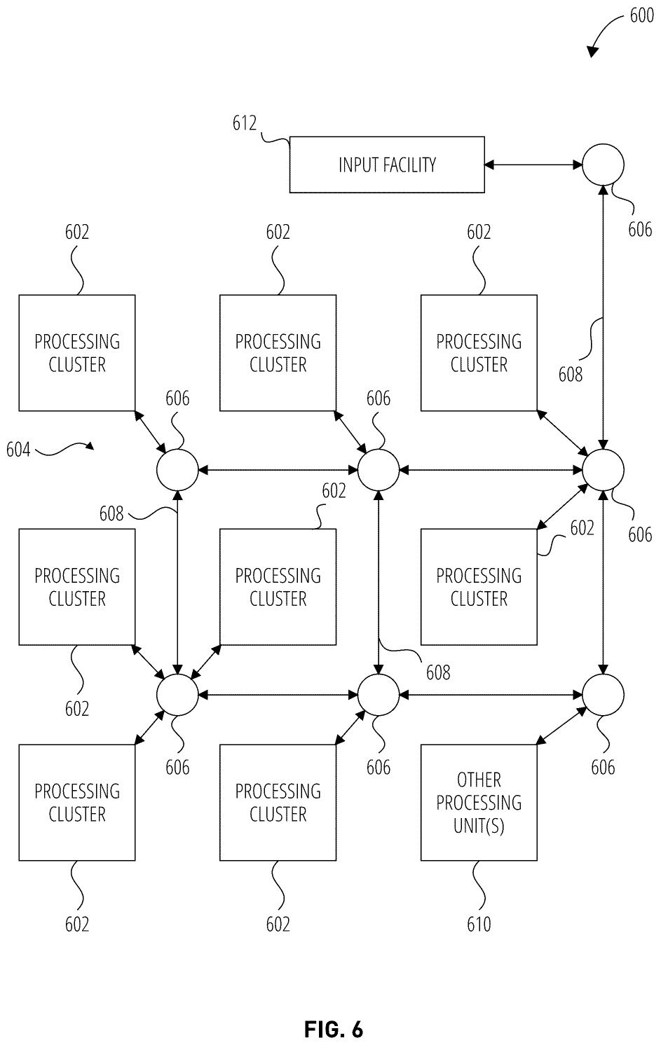

In some examples, the model management system 136 is designed to facilitate the deployment of machine learning models directly onto user systems 102, where they can be executed on-chip. This approach may be advantageous for applications that demand real-time processing, such as AR, digital assistants, real-time object detection, or real-time audio monitoring. In some examples, a user system 102 employs an event-driven processing system, such as the processing system 600 of FIG. 6 (described elsewhere), to process neural networks.

By pushing quantized and optimized models to user systems 102, the model management system 136 may ensure that the computational workload is handled locally, thereby minimizing latency and reliance on continuous connectivity. On-chip execution of models may also conserve bandwidth and reduce server load, which can be significant when scaling to a large number of users. Furthermore, running models on-chip may allow for enhanced user privacy and security, as sensitive data can be processed locally without being transmitted to external servers.

The model quantization system 138 is responsible for processing and/or adjusting model parameters, for example, to optimize or adapt them for storage and computational efficiency. This may involve reducing the prediction of the parameters of a machine learning model. The model quantization system 138 may identify possible quantization configurations, select suitable quantization configurations to apply to a model, evaluate the impact of quantization on model performance, and perform quantization. In some examples, the model quantization system 138 receives quantization requests from users (e.g., via the network 108) and returns (e.g., to the model management system 136 or to a user system 102) a new instance of a machine learning model that has quantized parameters. The model quantization system 138 may be designed to handle different types of machine learning models, such as different types of neural networks, and can be tailored to support various deployment environments, from high-performance servers to resource-constrained edge devices. The model quantization system 138 can provide features of a compiler to facilitate compiling of a machine learning model into a format suitable for running on a particular hardware environment.

In some examples, for efficiently saving model weights on hardware associated with a user system 102, the model quantization system 138 may utilize a quantization approach that involves representing values in a weight tensor by a sign bit, a number of exponent bits (e), and a number of mantissa bits (m). This can be referred to as the “bit settings” associated with a model or part of a model. An example of a number representation format is the “AdaptivFloat” representation format described by Tamble et al. in “AdaptivFloat: A Floating-Point Based Data Type for Resilient Deep Learning Inference” (arXiv: 1909.13271v3). It is noted that the number of exponent bits or the number of mantissa bits can be zero in some cases.

One quantization approach is to automatically select bit settings based on the error introduced on the weights values compared to their original values. However, instead of following this approach, examples described herein provide a technical solution that involves minimizing the error on outputs (e.g., feature maps) associated with a quantized tensor compared with original outputs. For example, in the context of a neural network, the model quantization system 138 is designed to minimize the difference between the values of feature maps of a layer (including an activation or threshold if present) with and without quantized weights. Quantizing a model using such bit settings may lead to increased accuracy.

Referring again more broadly to the interaction system 100, the interaction system 100 may thus embody multiple subsystems, which are supported on the client-side by the interaction client 104 and on the server-side by the interaction system servers 124. In some examples, one or more of these subsystems are implemented as microservices. A microservice subsystem (e.g., a microservice application) may have components that enable it to operate independently and communicate with other services. Example components of a microservice subsystem may include:
Function logic: The function logic implements the functionality of the microservice subsystem, representing a specific capability or function that the microservice provides.
API interface: Microservices may communicate with other components through well-defined APIs or interfaces, using lightweight protocols such as representational state transfer (REST) or messaging. The API interface defines the inputs and outputs of the microservice subsystem and how it interacts with other microservice subsystems of the interaction system 100.
Data storage: A microservice subsystem may be responsible for its own data storage, which may be in the form of a database, cache, or other storage mechanism (e.g., using the database server 126 and database 128). This enables a microservice subsystem to operate independently of other microservices of the interaction system 100.
Service discovery: Microservice subsystems may find and communicate with other microservice subsystems of the interaction system 100. Service discovery mechanisms enable microservice subsystems to locate and communicate with other microservice subsystems in a scalable and efficient way.
Monitoring and logging: Microservice subsystems may need to be monitored and logged in order to ensure availability and performance. Monitoring and logging mechanisms enable the tracking of health and performance of a microservice subsystem.

In some examples, the interaction system 100 employs a monolithic architecture, a service-oriented architecture (SOA), a function-as-a-service (FaaS) architecture, or a modular architecture.

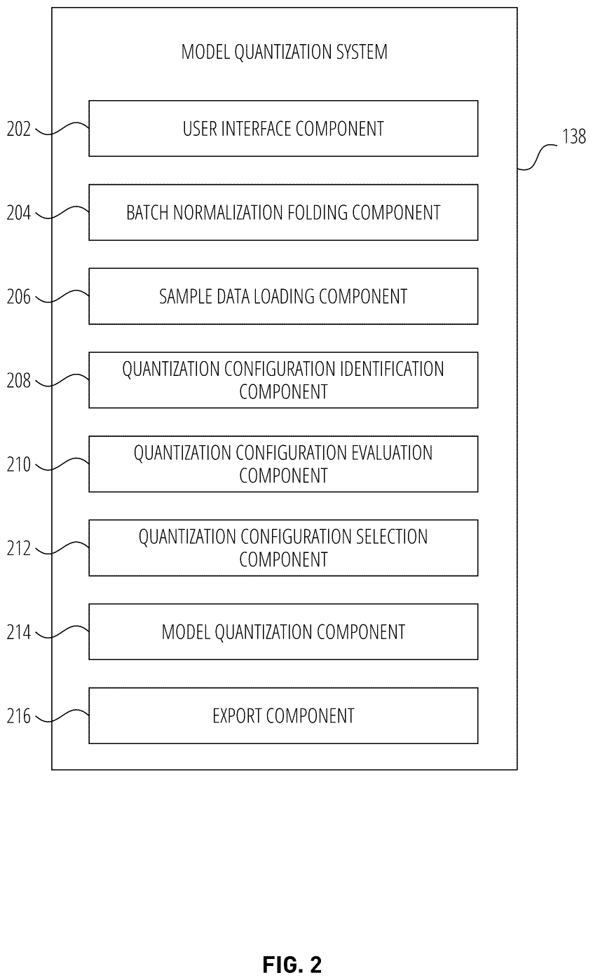

FIG. 2 is a block diagram illustrating certain components of the model quantization system 138 of FIG. 1, according to some examples. In FIG. 2, the model quantization system 138 is shown to include a user interface component 202, a batch normalization folding component 204, a sample data loading component 206, a quantization configuration identification component 208, a quantization configuration evaluation component 210, a quantization configuration selection component 212, a model quantization component 214, and an export component 216.

The user interface component 202 enables communication between a user (e.g., a user of a user system 102) and the model quantization system 138. The user interface component 202 may provide one or more interfaces that allow users to input specific quantization requirements, select models for quantization, provide sample data, and/or configure quantization parameters. For example, a user can specify a desired bit precision for model parameters (or multiple different bit precisions for different components of a machine learning model) or choose between different quantization schemes offered by the model quantization system 138. An interface may also be provided by the model quantization system 138 to present users with options to review and adjust quantization configurations based on system recommendations or performance metrics.

In some examples, the user interface component 202 provides one or more APIs that serve as conduits for transmitting user inputs, such as quantization parameters and model selection criteria, to other components of the model quantization system 138. For example, such an API can be designed to handle a variety of user-specified parameters, including, but not limited to, the number of exponent and mantissa bits for floating-point quantization, the selection of layers, channels, or maps within a neural network model for targeted quantization, and/or a choice of loss functions to evaluate quantization efficacy.

A user may also be enabled to upload input datasets to serve as sample data for evaluating various quantization configurations. The user interface component 202 may also allow users to invoke certain components of the model quantization system 138, such as the batch normalization folding component 204, which integrates batch normalization parameters into weights of a model prior to quantization. The user interface component 202 may provide graphical user interfaces allowing users, for example, to track status through a real-time progress indicator and receive notifications upon completion of quantization. The user interface component 202 may further allow a user to download or export a new instance of a model or its quantized parameters for downstream use.

In some examples, a user can explicitly select to perform “activation-aware” quantization when transmitting a quantization request to the model quantization system 138. The model quantization system 138 may then automatically utilize techniques described herein to select one or more optimal or recommended quantization configurations.

The model quantization system 138 may implement the batch normalization folding component 204 to handle, for example, integration of batch normalization layers into adjacent layers of a neural network. The model quantization system 138 may analyze a network architecture to identify batch normalization operations and calculate the necessary adjustments to the weights and biases of surrounding layers to incorporate these operations directly. As a result, the batch normalization folding component 204 may automatically reduce computational complexity of a machine learning model and prepare it for more efficient quantization. For example, in a deep learning model, the batch normalization folding component 204 merges the normalization parameters with the convolutional filters, thereby eliminating the need for at least some separate normalization computations during inference.

The sample data loading component 206 is responsible for importing and/or managing input datasets (e.g., sample data) required for the quantization process. In some examples, the sample data loading component 206 communicates with the user interface component 202 to obtain user-provided samples and to load them for analysis. In other examples, the sample data loading component 206 retrieves sample data from a storage component, such as the database 128 of FIG. 1.

In some examples, sample data are used to evaluate the impact of different quantization configurations on performance. The sample data loading component 206 may handle preprocessing and formatting of the sample data. For instance, the sample data loading component 206 can automatically resize images, normalize values, and/or batch inputs to facilitate efficient processing.

The quantization configuration identification component 208 is responsible for identifying or generating a set of potential quantization configurations for parameters of a machine learning model. The potential quantization configurations are referred to herein as candidate quantization configurations. The quantization configuration identification component 208 may employ algorithms to explore various combinations of bit allocations for different parameters, such as the number of bits for the exponent and mantissa in floating-point representations or the granularity of fixed-point representations. For example, the quantization configuration identification component 208 can identify all possible or feasible bit-setting permutations that satisfy certain constraints (e.g., user-selected bit precision or layer-specific constraints).

The quantization configuration identification component 208 may be configured to take into account any user-provided specifications (such as a selected bit precision), model architecture, and/or the computational constraints of a target deployment environment to propose a range of quantization strategies. For example, the quantization configuration identification component 208 can identify configurations with different bit widths for a convolutional layer's weights, each with its own trade-off between model size and expected accuracy.

The quantization configuration evaluation component 210 assesses the performance of each candidate quantization configuration generated or identified by the quantization configuration identification component 208. This evaluation may be automatically performed by applying the candidate configurations to a model and measuring the resulting impact on accuracy using the sample data provided or accessed by the sample data loading component 206. The quantization configuration evaluation component 210 may run or execute a machine learning model on sample data, both with and without quantized parameters, to obtain reference outputs and candidate outputs for comparison with the reference outputs.

The quantization configuration evaluation component 210 may utilize one or more metrics to quantify deviation in performance from the original, unquantized model. For example, the quantization configuration evaluation component 210 can automatically apply a loss function to determine the efficacy of each quantization configuration. The quantization configuration evaluation component 210 can evaluate each candidate quantization configuration by assessing outputs within the model, such as feature map values (e.g., activations), instead of assessing the parameters (e.g., weights) themselves. Where a model includes non-linear transformations, such as those caused by activation functions and/or threshold functions, the quantization configuration evaluation component 210 may consider the resulting values after such non-linear transformations have been applied.

The quantization configuration selection component 212 may be configured to select the most appropriate quantization configuration (or a set of quantization configurations, e.g., where different configurations are to be applied to different components) based on the evaluations conducted by the quantization configuration evaluation component 210 on the candidate quantization configurations. For example, the quantization configuration selection component 212 may employ one or more decision criteria, such as minimizing the loss function, maintaining a threshold level of accuracy, or adhering to specific resource constraints. The quantization configuration selection component 212 may consider user objectives and the operational context to choose a configuration that best balances, for example, model performance with the practical requirements of the deployment environment.

In some examples, the model quantization system 138 is configured to allocate the bit setting (from a number of candidates) associated with a quantized tensor that produces the lowest overall error (e.g., L1 Loss or L2 Loss) on the outputs (e.g., feature map values) of a particular layer when compared to the outputs of that layer when run using an unquantized version of the tensor. In some examples, the same sample data is used to obtain the outputs for the quantized scenarios and for the unquantized (e.g., original) scenario. As mentioned, in some cases, if a layer is followed by a threshold layer, the outputs of the threshold layer may be checked and compared instead of the prior layer.

The model quantization component 214 may operate as an execution engine within the model quantization system 138 that applies a selected quantization configuration to a machine learning model. For example, the model quantization component 214 may transform parameters of a trained machine learning model, such as weights and biases, from an original high-precision format into the lower-precision format specified by the chosen configuration (as selected from a plurality of candidate quantization configurations). The model quantization component 214 may handle various aspects of quantization, such as bit setting implementation, rounding, truncating, or re-encoding parameter values.

The model quantization component 214 may compile a final version of the machine learning model, which is a new instance of the originally trained machine learning model (as a result of its quantized parameters). In some examples, the model quantization component 214 is provided by a dedicated compiler component that converts a machine learning model to a version that can be executed on a specific hardware device. Example features of such a compiler component are described elsewhere herein.

The export component 216 may be used to facilitate distribution of a quantized model or its parameters. The export component 216 may package model parameters and associated metadata into a suitable format for a target platform (e.g., target hardware). The export component 216 may handle tasks such as saving the quantized model to a file, transferring the model to a specified location, or integrating the model into an application or service. The export component 216 may facilitate on-chip deployment of a trained and quantized machine learning model, e.g., on an edge device or a wearable device (e.g., the head-wearable apparatus 116 of FIG. 1). As mentioned elsewhere, models that are quantized in this manner may be deployed to a user system 102 that employs an event-driven processing system, such as the processing system 600 of FIG. 6. Exported parameters may also be used in other downstream operations, such as “activation-aware” training of one or more further machine learning models.

Examples described herein thus diverge from techniques that focus solely on minimizing the error between the quantized and original parameter values. Instead, the model quantization system 138 may evaluate the quantization's impact on model output (e.g., intermediate outputs such as feature map values). This approach may be beneficial in complex models such as deep neural networks, where the relationship between parameters and outputs can be non-linear, and where preserving the integrity of activations can be crucial for maintaining performance.

In some examples, at least some of the components shown in FIG. 2 are configured to communicate with each other to implement aspects described herein. One or more of the components described herein may be implemented using hardware (e.g., one or more processors of one or more machines) or a combination of hardware and software. For example, a component described herein can be implemented by a processor configured to perform the operations described herein for that component. Moreover, two or more of these components may be combined into a single component, or the functions described herein for a single component may be subdivided among multiple components. Furthermore, according to various examples, components described herein can be implemented using a single machine, database, or device, or be distributed across multiple machines, databases, or devices.

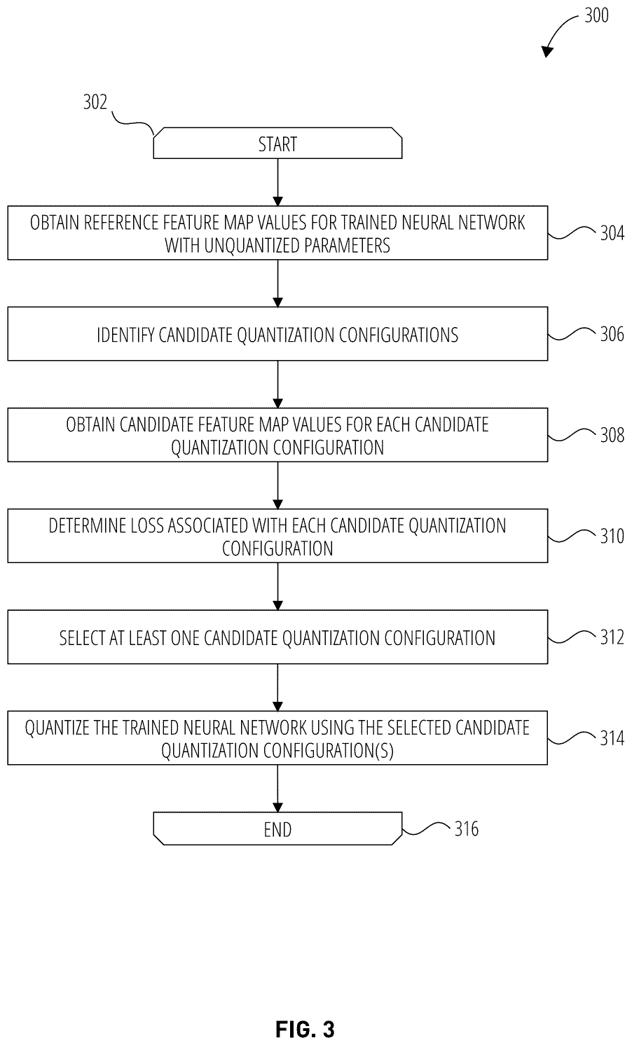

FIG. 3 is a flowchart illustrating operations of a method 300 suitable for selecting one or more quantization configurations for a trained machine learning model, according to some examples. By way of example and not limitation, aspects of the method 300 may be performed by one or more components of the model quantization system 138 of FIG. 1 and FIG. 2. Accordingly, the model quantization system 138 is used as an example in the description of FIG. 3 below. However, the model quantization system 138 is a non-limiting example of a system that can perform the method 300, and it will be appreciated that the method 300 may also be performed using one or more other systems, components, devices, or architectures.

In the method 300 of FIG. 3, parameters of a trained machine learning model in the example form of a trained neural network are to be quantized to reduce the overall size of the trained neural network prior to deployment. The individual components of the trained neural network that are analyzed for quantization are respective layers of the trained neural network. Each layer has its own respective parameters (e.g., weights resulting from a training process).

The method 300 commences at opening loop element 302 and proceeds to operation 304, where the model quantization system 138 obtains reference outputs (e.g., using the quantization configuration evaluation component 210). In this example, the reference outputs are reference feature map values for each layer of the trained neural network that is selected for quantization.

Generally, feature map values are outputs generated by applying a set of learned parameters, such as the weights and biases of a neural network, to a given input within a specific component of a model. In the context of convolutional neural networks, for example, feature maps are the result of convolving filters over the input data, capturing patterns or features at different locations of the input. For instance, in image processing, feature map values might represent the presence of certain textures or shapes at different positions in the image. These values can be important for a model to understand and abstract various aspects of the data as it progresses through the network. Feature map values may represent activations, or activated responses of a network to specific features or patterns detected in the input.

To obtain the reference feature map values in the method 300, the model quantization system 138 may execute the trained neural network on an input dataset (e.g., sample data) using unquantized parameters (e.g., the original weights determined during training for each layer). This results in outputs that are based on unquantized parameters. These outputs serve as a baseline or point of reference and can thus be referred to as the reference feature map values. In some examples, where a layer is associated with or followed by a non-linear transformation, such as a threshold function, the reference feature map values used for the layer are the values obtained after the non-linear transformation.

At operation 306, the model quantization system 138 identifies candidate quantization configurations (e.g., using the quantization configuration identification component 208). For example, for each component (in this case, each layer) of the trained neural network that has parameters to be quantized, the model quantization system 138 identifies multiple possible bit settings that could be implemented while satisfying a selected bit precision.

The method 300 proceeds to operation 308, where the model quantization system 138 obtains candidate feature map values for each candidate quantization configuration (e.g., using the quantization configuration evaluation component 210). For example, the model quantization system 138 applies the relevant candidate quantization configuration to the trained neural network, and then executes the trained neural network on the same input dataset as was used to obtain the reference feature map values to obtain outputs. Since these outputs are associated with the particular candidate quantization configuration and will be used for comparison with the reference outputs, the outputs are referred to as candidate feature map values.

In some examples, where a layer is associated with or followed by a non-linear transformation, such as a threshold function, the candidate feature map values used for the layer are the values obtained after the non-linear transformation. In some examples, given that the same input dataset is used and non-linearities are taken into account in both cases, the reference feature map values and the candidate feature map values for a particular component (e.g., layer) can thus be compared in a like-for-like manner.

At operation 310, the model quantization system 138 determines a loss associated with each candidate quantization configuration (e.g., using a suitable loss function). For example, for a particular layer of the trained neural network, the model quantization system 138 uses the quantization configuration evaluation component 210 to calculate the deviation of its candidate feature map values (generated using a specific candidate quantization configuration) from the reference feature map values that were generated for that same layer. This operation may be performed for each candidate quantization configuration with respect to the relevant reference feature map values.

The model quantization system 138 then selects at least one candidate quantization configuration at operation 312. For example, the model quantization system 138 uses the quantization configuration selection component 212 to select a candidate quantization configuration for each layer under consideration based on the determined losses associated with the candidate quantization configurations that were identified for that layer. The model quantization system 138 may in each case select the candidate quantization configuration that results in a lowest value for a selected loss function.

Accordingly, in some examples, different quantization configurations may be selected for quantizing the parameters of different components (e.g., layers). However, in other examples, a single quantization configuration may be selected for use across multiple or all components of the neural network. In the latter case, loss may be determined by comparing overall, aggregate, or average loss between reference outputs and candidate outputs across multiple components.

The method 300 proceeds to operation 314, where the model quantization system 138 quantizes the trained neural network (or part thereof) using the one or more selected candidate quantization configuration. For example, parameters (e.g., weights and biases) of the neural network are automatically quantized by the model quantization component 214 using selected bit settings for each component (e.g., layer), which reduces the precision of the parameters and consequently their storage size. The quantized parameters may then be converted into a format suitable for storage on target hardware. This may involve packing the parameters into a binary format that aligns with the hardware's memory architecture.

The converted, quantized parameters may then be transferred to the hardware (e.g., to a processing system such as the processing system 600 of FIG. 6) and subsequently used to perform inference tasks. Moreover, the resulting configurations can be exported using the export component 216 and used in downstream quantization methods. The method 300 concludes at closing loop element 316.

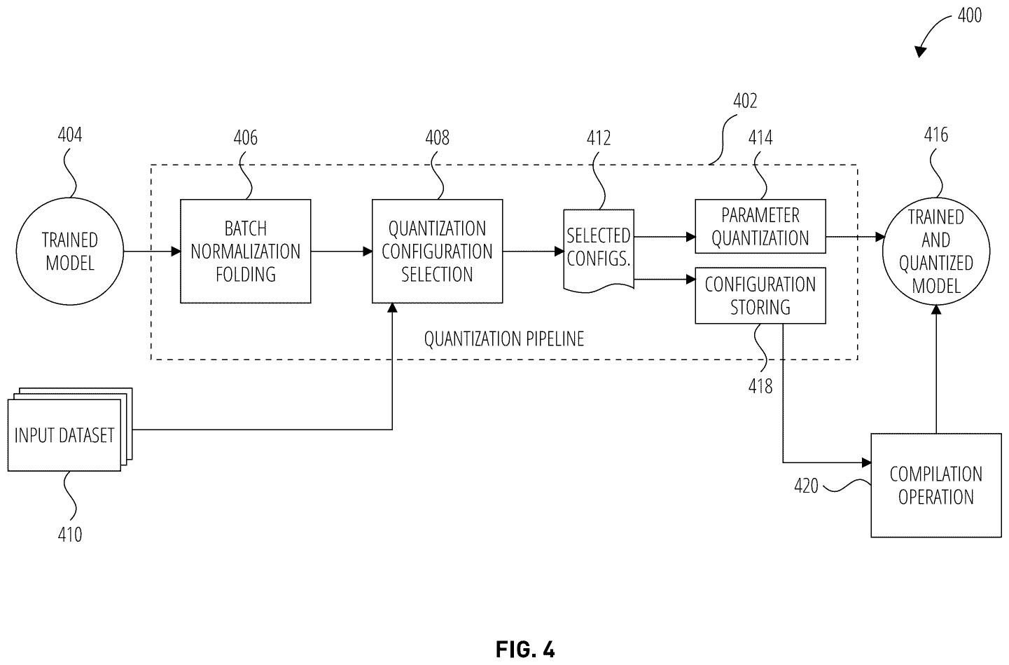

FIG. 4 shows a diagram 400 illustrating a quantization pipeline 402, according to some examples. By way of example and not limitation, aspects of the quantization pipeline 402 may be implemented using one or more components of the model quantization system 138 of FIG. 1 and FIG. 2. Accordingly, the model quantization system 138 is used as an example in the description of FIG. 4 below. However, the model quantization system 138 is a non-limiting example of a system that can be used to implement the quantization pipeline 402, and it will be appreciated that one or more other systems, components, devices, or architectures may also be used.

The quantization pipeline 402 is used to automatically transform a trained machine learning model with unquantized parameters (trained model 404) to a new instance or version that has quantized parameters (trained and quantized model 416). FIG. 4 illustrates that the quantization pipeline 402 may include batch normalization folding 406, quantization configuration selection 408, and parameter quantization 414. In some examples, instead of parameter quantization 414, the quantization pipeline 402 includes configuration storing 418, which is followed by a compilation operation 420, as will be described below.

In some examples, batch normalization folding 406 is a technique performed by the model quantization system 138 to integrate batch normalization layers of a neural network into adjacent layers to simplify the network architecture and enhance the quantization process. Batch normalization can stabilize and/or accelerate the training of deep neural networks by normalizing the inputs of each layer. However, for inference purposes, these normalization calculations can be merged into the weights and biases of the preceding or subsequent layers, effectively “folding” them into the network. This folding process results in a reduced number of operations and parameters, facilitating a more efficient quantization by minimizing the computational overhead and potential quantization errors.

After batch normalization folding 406 has been performed with respect to the trained model 404, the model quantization system 138 performs quantization configuration selection 408. In some examples, batch normalization may not be relevant and the quantization pipeline 402 may thus commence with quantization configuration selection 408.

Quantization configuration selection 408 may be a process of automatically determining an efficient quantization strategy for the machine learning model in question. As described with reference to FIG. 3, the model quantization system 138 may evaluate various potential quantization configurations, referred to as candidate quantization configurations, each of which specifies how the parameters should be quantized. The model quantization system 138 may perform this evaluation with reference to certain constraints. For example, overall bit precision may be preselected and fixed, with the model quantization system 138 being tasked with determining how to allocate bit types (such as exponent and mantissa bits) while satisfying the overall bit precision.

During quantization configuration selection 408, the model quantization system 138 may use an input dataset 410 to assess the impact of each candidate quantization configuration on model performance. For example, the model quantization system 138 measures the loss or accuracy degradation when the trained model 404 is quantized according to each configuration. As mentioned, this may involve comparing, for a particular component (e.g., layer of a neural network), candidate output values (e.g., candidate feature map values) generated while applying quantized parameters according to a particular candidate quantization configuration with reference output values (e.g., reference feature map values) that were generated while applying unquantized parameters (e.g., using the trained model 404 with its original parameter values).

As explained elsewhere, the input dataset 410 used by the model quantization system 138 may be a relatively small set of samples (e.g., approximately 100 unlabeled sample images in the case of image processing) that is used to obtain both the reference output values and the respective candidate output values. The model quantization system 138 may select a configuration (e.g., specific bit settings) that minimizes this loss or degradation for a particular component or collection of components.

Based on this assessment, the model quantization system 138 selects a candidate quantization configuration, or a set of candidate quantization configurations (e.g., one configuration per layer or other component). For example, and as shown in FIG. 4, the output of quantization configuration selection 408 can be selected configurations 412. As an example, the selected configurations 412 can specify, for each quantizable layer of the trained model 404, the number of exponent bits and the number of mantissa bits, respectively, to use during parameter quantization 414. The selected configurations 412 thus determine how parameter quantization 414 is to be performed.

The model quantization system 138 may convert parameters, such as weights of a neural network, from high-precision representations to lower-precision formats. Parameter quantization 414 may be carried out differently for different components of the trained model 404, such as by utilizing respective quantization configurations for respective layers and/or channels. For example, critical parameters that significantly affect the trained model 404 output can be quantized with higher precision, while less impactful parameters can be represented with fewer bits to conserve memory and computational resources. The model quantization system 138 may automatically adjust bit settings (such as a bit precision for a particular layer) based on such determinations and/or user input may be used to guide the parameter quantization 414. In some examples, once parameter quantization 414 has been completed, the quantization pipeline 402 culminates in the trained and quantized model 416.

In some examples, instead of performing parameter quantization 414 directly after determining the selected configurations 412, configuration storing 418 is performed by the model quantization system 138 to store the selected configurations 412. At a later stage, the trained and quantized model 416 can then be compiled in the compilation operation 420 shown in FIG. 4. The model quantization system 138 can include a compiler component that is configured to convert the trained model 404 into a format compatible with deploying on particular hardware, such as on a Neural Processing Unit implemented as described with reference to FIG. 6. By using the configuration provided by the quantization pipeline 402, the compiler component can quantize the parameters of the relevant model correctly.

In use, a user (e.g., using the user system 102 of FIG. 1) may call a suitable function to trigger the quantization pipeline 402 shown in FIG. 4. For example, the user can call an “ActivationAwareQuantization” module hosted at the model quantization system 138, specifying model details and the total number of bits (n_bits). The model quantization system 138 then calculates the bit settings, for example, a dictionary with, as keys, the (quantizable) layer names, and, as values, their respective recommended bit settings, which were used to quantize the relevant layers. Bit settings may comprise a tuple containing the number of exponent bits and the number of mantissa bits. For each quantizable layer, output feature maps may be compared via L1 Loss with the original (reference) feature maps of the unquantized model, for each bit setting (e, m). For example, the bit settings corresponding to the lowest L1 Loss may be stored in a configuration and passed to a “quantize_model” function.

L1 Loss and L2 Loss are non-limiting examples of loss functions that can be used to evaluate candidate outputs against reference outputs. L1 Loss refers to the average of the absolute differences between the candidate values (for a particular candidate quantization configuration) and the reference values. L2 Loss refers to the average of the squares of the differences between the candidate values (for a particular candidate quantization configuration) and the reference values.

A user may thus use their user device (e.g., a user system 102 of FIG. 1) to submit a quantization request (e.g., a function call as described above) to the model quantization system 138. In response, the model quantization system 138 may generate and/or return proposed bit settings, or a new instance or version of the trained model 404 that has quantized parameters (e.g., the trained and quantized model 416).

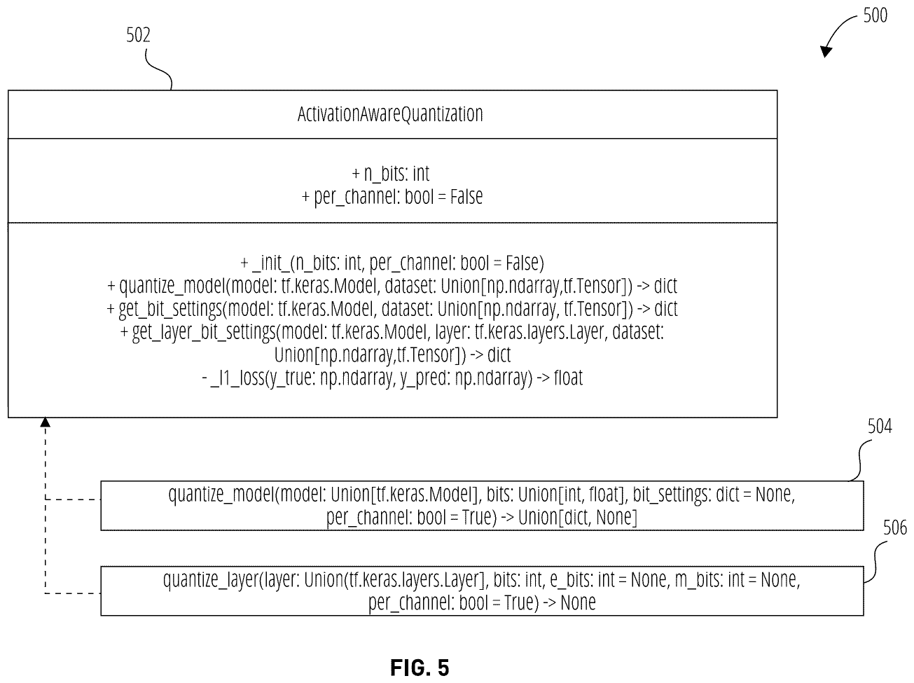

FIG. 5 is a UML diagram 500 that outlines the structure and relationships of an activation-aware quantization class 502 and associated functions, according to some examples. The activation-aware quantization class 502 may be used as part of a system designed to perform quantization of machine learning models (e.g., the model quantization system 138), specifically tailored for neural networks implemented using TensorFlow's Keras™ API. For example, the activation-aware quantization class 502 can be made accessible via an API to assist a user (e.g., a user of a user system 102 of FIG. 1) with efficient quantization. It is noted that the use of the TensorFlow™ framework is a non-limiting example, and other frameworks, such as PyTorch™ may also be used to implement activation-aware quantization.

The activation-aware quantization class 502 is linked to functions that facilitate the quantization of neural network parameters, ensuring that the precision of the model's computations is tuned to balance performance with computational efficiency. In some examples, the API through which the activation-aware quantization class 502 is accessed provides users with the necessary tools to apply a quantization strategy to their neural networks, streamlining the process of model optimization for deployment in resource-constrained environments.

As can be seen in FIG. 5, attributes of the activation-aware quantization class 502 include an integer (n_bits) that specifies the number of bits to be used for quantization, and a Boolean flag (per_channel) that indicates whether quantization should be performed per channel or not (e.g., whether quantization settings are shared for an entire layer or whether the quantization settings are shared per input channel). Methods of the activation-aware quantization class 502 include a constructor for the class, which initializes the “ActivationAwareQuantization” object with the specified number of bits and the per-channel flag.

Methods of the activation-aware quantization class 502 further include:
“quantize_model,” which takes a TensorFlow Keras™ model and a dataset as inputs and returns a dictionary of quantization configurations;
“get_bit_settings,” which computes and returns the bit settings for quantizing the model based on the provided dataset (as described elsewhere herein, a compiler component can be used downstream to perform quantization, and in such cases the compiler component may use these bit settings);
“get_layer_bit_settings,” which calculates and returns the bit settings for quantizing a specific layer within the model; and
“_l1_loss,” which calculates the L1 Loss. This is the absolute difference between the true values (y_true), also referred to herein as reference outputs, and the predicted values (y_pred), also referred to herein as candidate outputs. L1 Loss is used as the metric to assess the quantization error in this example.

The associated functions include a model quantization function 504 and a layer quantization function 506. The model quantization function 504 is responsible for applying the quantization configurations to the model. It takes additional parameters such as the number of bits and whether the quantization is per channel. In some examples, the “bit_settings” parameter is a dictionary with, as keys, layer names, and, as values, their bit settings as a tuple containing the number of exponent and mantissa bits, respectively. It returns a dictionary or “None,” depending on whether the quantization is successful.

The layer quantization function 506 is used to quantize individual layers of the model. It takes parameters such as the layer to be quantized, the number of bits for quantization, and the number of exponent bits (e_bits) and mantissa bits (m_bits) if the quantization is to be done using a floating-point representation. The “per_channel” flag indicates if the quantization should be applied per channel.

Some inputs may be redundant or optional. For example, where the number of bits and the number of “e_bits” are already specified, the number of “m_bits” can only have one value and its input can thus be made redundant or optional.

FIG. 6 illustrates a processing system 600 according to some examples. The processing system 600 is configured for event-based processing tasks. In some examples, the components of the processing system 600 are integrated into a single processing unit (e.g., a Neural Processing Unit). For example, the processing system 600 may be implemented as a Neural Processing Unit in an Application-Specific Instruction Processor (ASIP) designed to facilitate inference on edge-of-cloud devices.

The processing system 600 includes a plurality of processing clusters 602, which are interconnected by a network 604. The network 604 functions as a message exchange network for exchange of messages, including event messages, instruction messages, configuration messages, or other messages, depending on the implementation. Messages may thus include instructions to perform computations, configuration instructions, or other data.

The network 604 includes nodes 606 forming an interface with respective processing clusters 602 and links 608 between the nodes 606. Processing units of one or more other types, such as one or more other processing unit(s) 610 as shown in FIG. 6, may also be included in the processing system 600 and coupled to the network 604. For example, the one or more other processing unit(s) 610 may include a digital signal processor, general purpose processor (e.g., a Central Processing Unit (CPU)), host processor, or Graphics Processing Unit (GPU).

In some examples, each processing cluster 602 has a message receiving facility to receive event messages via the network 604 and a message transmitting facility to transmit event messages via the network 604. Each of the processing clusters 602 may include one or more processing elements (not shown). Each processing element may be a neural processing element that, in the context of neural network processing, mimics the behavior of a biological neuron (at least to some extent), as is described further below.

Each of the processing clusters 602 may include its own local memory or cache, allowing for rapid data access. For example, a neuromorphic state memory can store values representative of a neuromorphic state associated with one or more processing elements. Processing elements may have their own respective memory storing their state or other information, or each processing cluster 602 may have a memory that stores state or other information for multiple processing elements.

In some examples, each processing cluster 602 has its own static random access memory (SRAM) (e.g., 256 kB of SRAM). Neuromorphic states may be calculated using, for example, 32-bit floating point or 16-bit floating point.

The processing system 600 may further include an input facility 612 that is configured to receive input data. The input facility 612 may also selectively map messages. As a result, the processing clusters 602 may not only transmit messages directly, but may also have their messages indirectly redirected and broadcast via the input facility 612. For example, the input facility 612 can be configured to receive messages with message content and determine the destination of each respective message (e.g., using a mapping function and/or an element address and/or data values in the messages).

Different processing clusters 602 may be configured for different tasks. For example, some clusters can be dedicated to performing basic arithmetic computations, some clusters can be dedicated to neuromorphic computations, and other clusters can be dedicated to performing complex mathematical operations. In some examples, the processing clusters 602 are configured to perform neural network processing, while the one or more other processing unit(s) 610 perform other computational tasks. Alternatively or additionally, processing clusters may be provided that are capable of being reconfigured to perform one of various classes of operations. Likewise, a processing cluster may have a plurality of processing elements that may have the same functionality or different functionalities, or may be reconfigured to have a particular functionality.

Each processing element may be designed or configured to detect and generate event messages based on specific computational rules (e.g., spike when a threshold is exceeded). Neuromorphic states may be dynamically updated based on received event messages and computations performed within a processing cluster 602. In some examples, if the value of a neuromorphic state approaches or exceeds a threshold potential, the corresponding processing element can issue a control signal, prompting the message transmitting facility to send out one or more event messages (e.g., to other processing clusters 602 in the processing system 600).

The processing system 600 can be employed in various applications, such as image processing, audio processing, machine learning, pattern recognition, or real-time data analytics. For example, in an image processing application, the processing clusters 602 may be utilized to perform convolutional operations on image data, while another processing unit (e.g., the other processing unit(s) 610) may handle tasks such as image rendering or video encoding.

The processing system 600 may efficiently handle layer-by-layer processing in a neural network context. As described in greater detail below, the processing system 600 may utilize the processing elements in the processing clusters 602 to perform convolution operations that involve applying kernels, or filters, over input data (e.g., image data) to create feature maps. The processing elements may also apply other operations, such as activation functions. In some examples, different layers of the neural network may be assigned to different subsets of the processing clusters 602 for efficient execution.

Deep neural networks (e.g., convolutional neural networks, or CNNs) comprise a plurality of neural network layers. Each neural network layer typically includes a plurality of neural network computation elements. Neural network computation elements in a layer may receive weighted inputs from neural network computation elements in a preceding layer or an input device and in turn may have outputs to neural network computation elements in a succeeding layer. The specific way in which a neural network layer is connected to a preceding layer depends on its type. By way of example, in a fully-connected layer, each neural network computation element may receive an input from a neural network computation element in a preceding layer. In a convolutional layer, each neural network computation element may receive an input from a neural network computation element of a preceding layer that is within the range of a convolution kernel centered around a local address corresponding to a local address in the convolutional layer. A pooling layer is used for a spatial dimension reduction. Respective neural network computation elements of a pooling layer correspond to respective sets of neural network computation elements in the preceding layer. A pooling operation for a respective neural network element of a pooling layer, for example, involves selecting a value from its respective set of neural network elements in the preceding layer, such as sampling a maximum value, a minimum value, a median value, or a value of a specific one of the respective set of neural network elements. Alternatively, the pooling operation involves computing the average value from the respective set of neural network elements in the preceding layer.

An event-based or message-based processing system, such as the processing system 600, can be configured as a deep neural network. In such cases, at least some of the processing elements of the processing clusters 602 are configured as neural network computation elements that may function as described above. In some examples, the processing elements can be provided as dedicated hardware that function as neural network computation elements. In other examples, this can be achieved by configuring the processing system 600 such that the processing elements are programmable to function as neural network computation elements. In some examples, each processing element has a dedicated processor, while in other examples, the processing elements of a processing cluster 602 share a processor. In operation, the processing elements of the processing clusters 602 may thus, when configured or functioning as neural network elements, receive input messages and transmit output messages via the network 604.

In some examples, each processing cluster 602 functions as a neuron core. Each processor cluster 602 may be configured to operate using single instruction, multiple data (SIMD) processing. For example, each processing cluster 602 can be configured to perform a single instruction on four data inputs in parallel.

In some examples, since each processing cluster 602 has its own processing capabilities and memory, it is possible to scale the neuron capacity of the processing system 600 to create a mesh network-on-chip (NOC) of neuron cores of a desired size, capacity, or performance.

When processing a neural network, the processing system 600 implements event-based processing. For example, a neuron activation is only propagated through the network 604 if its value constitutes an “event” (e.g., a value is non-zero or exceeds a threshold value). The processing system 600 therefore exploits sparsity by, for example, only considering certain values as “events.” Since only active neurons transmit data, when compared to a conventional architecture that may process all neuron values, this reduces the volume of data that needs to be processed and transferred, enhancing efficiency.

The processing system 600 may benefit from quantization techniques as described herein. For example, by selecting quantization configurations and quantizing parameters of a neural network prior to deploying the neural network (e.g., through on-chip storage) to the processing system 600 for inference, memory footprint of the neural network may be reduced while still ensuring accurate or high-performing inference.

A software development kit (SDK) may be used to convert machine learning models to a format in which they can be run on the processing system 600. For example, the SDK can be configured for profiling, compiling and mapping of CNNs onto a Neural Processing Unit implementing the processing system 600. The SDK may contain a compiler component that turns the machine learning model into a binary that the processing system 600 can run. A mapping may be created that contains hardware details and mapping constraints required to run on the actual hardware. Layers may be grouped and assigned to a specific core (e.g., a specific processing cluster 602). Layers that are too large to fit a single core can be split into multiple segments so that a layer can be distributed over multiple cores. As mentioned, the compiler component may perform quantization operations using selected configurations as described herein.

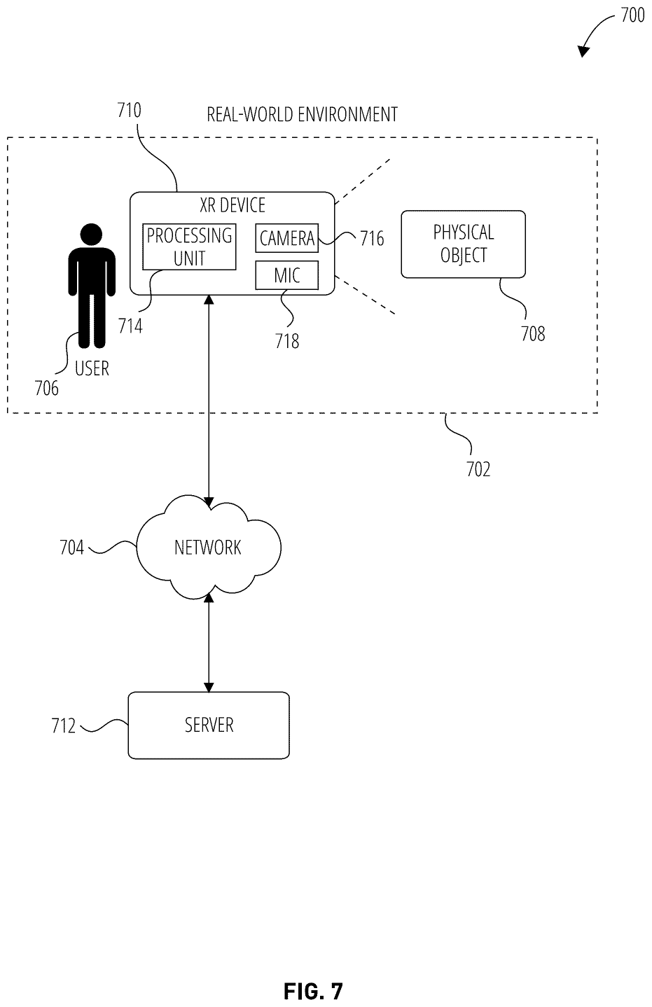

Referring now to FIG. 7, a diagram is shown to illustrate a network environment 700 suitable for operating an XR device 710, according to some examples. The network environment 700 includes an XR device 710 and a server 712, communicatively coupled to each other via a network 704. The server 712 may be part of a network-based system. For example, the network-based system may be or include a cloud-based server system that provides additional information, such as virtual content (e.g., three-dimensional models of virtual objects, or augmentations to be applied as virtual overlays onto images depicting real-world scenes) to the XR device 710.

The term “XR” refers to “extended reality,” which covers augmented reality (AR) and/or virtual reality (VR). The term “AR” refers to an interactive experience of a real-world environment where physical objects or environments that reside in the real world are “augmented” or enhanced by computer-generated digital content (also referred to as virtual content or synthetic content). An AR device can enable a user to observe a real-world scene while simultaneously seeing virtual content that may be aligned to or superimposed on objects, images, or environments in the field of view of the AR device. AR can also refer to a system that enables a combination of real and virtual worlds, real-time interaction, and three-dimensional (3D) representation of virtual and real objects. A user of an AR system can perceive virtual content that appears to be attached to, associated with, or interact with a real-world physical object.

The term “VR” refers to a simulation experience of a virtual world environment that is distinct from the real-world environment. Computer-generated digital content is displayed in the virtual world environment. A VR device may block out the field of view of the user with virtual content that is displayed based on a position and orientation of the VR device. VR also refers to a system that enables a user of a VR system to be completely immersed in the virtual world environment and to interact with virtual objects presented in the virtual world environment. In general, AR and VR devices are referred to as XR devices. A further device is based on mixed reality (“MR”), which typically represents a hybrid of AR and VR, in which world facing cameras acquire images that are merged with virtual content to be displayed on a VR device. An AR device is generally transparent or see through, while VR and MR devices are opaque or not see-through. The term “XR” may thus also refer to MR.

Referring again to FIG. 7, a user 706 operates the XR device 710. The user 706 may be a human user (e.g., a human being), a machine user (e.g., a computer configured by a software program to interact with the XR device 710), or any suitable combination thereof (e.g., a human assisted by a machine or a machine supervised by a human). The user 706 is not part of the network environment 700, but is associated with the XR device 710.

The XR device 710 may be a computing device with a display such as a smartphone, a tablet computer, or a wearable computing device (e.g., watch or glasses). The computing device may be hand-held or may be removably mounted to a head of the user 706. The XR device 710 includes various components, including a processing unit 714 and a camera 716. In some examples, the display may be a screen that displays what is captured with the camera 716 of the XR device 710. In other examples, the display of the device may be transparent or semi-transparent such as in lenses of wearable computing glasses. In other examples, the display can be a transparent display such as a windshield of a car, plane, or truck (e.g., as part of a heads-up display system). In another example, the display can be non-transparent and wearable by the user to cover the field of vision of the user.

The user 706 operates an application of the XR device 710. The application may include an AR application configured to provide the user 706 with an experience triggered or enhanced by a physical object 708, such as a two-dimensional physical object (e.g., a picture or navigation prompt), a three-dimensional physical object (e.g., a statue), a location (e.g., a factory), or references (e.g., perceived corners of walls or furniture, or Quick Response (QR) codes) in the real-world environment 702. For example, the user 706 may point the camera 716 of the XR device 710 to capture an image of the physical object 708 and a virtual overlay may be presented over the physical object 708 via the display. Certain experiences may also be triggered, enhanced, or controlled by a hand of the user 706. Accordingly, it will be appreciated that the physical object 708 or real-world object being tracked or detected by the XR device 710 may be the hand of the user 706.

To allow the user 706 to have an AR experience and/or interact with virtual objects, the XR device 710 may detect the positions and movements of objects, including, for example, one or both hands of the user 706. The XR device 710 may use hand positions, shapes, or movements to determine the user's intentions in manipulating virtual objects. To this end, the XR device 710 includes tracking components implemented using the processing unit 714. The tracking components may track the pose (e.g., position and orientation) of the XR device 710 relative to the real-world environment 702 using image sensors (e.g., the camera 716 and/or other image sensors), inertial sensors (e.g., a gyroscope, accelerometer, or the like), wireless sensors (e.g., Bluetooth™ or Wi-Fi sensors), a Global Positioning System (GPS) sensor, and/or an audio sensor (e.g., the microphone 718 shown in FIG. 7).

The processing unit 714 may be used to generate tracking estimates or predictions, e.g., to predict the location or pose of a tracked object. The XR device 710 may utilize one or more object tracking machine learning models or one or more object detection machine learning models for this purpose. A specific, non-limiting example of a machine learning model is a trained neural network for gesture recognition.

In this context, a machine learning model may comprise a neural network trained on suitable training data to identify and/or track objects in one or more frames captured by the XR device 710. In some examples, the components of the processing system 600 of FIG. 6 are integrated into a single processing unit. The processing unit 714 of the XR device 710 may comprise an event-driven processing system, such as the processing system 600. Accordingly, the XR device 710 is a (non-limiting) example of a computing device in which the processing system 600 can be implemented. The processing system 600 may, for example, facilitate real-time processing of sensor data captured by the XR device 710, such as image data captured using the camera 716 or audio data captured using the microphone 718.

In some examples, the XR device 710 benefits from quantization techniques as described herein. For example, by selecting quantization configurations and quantizing parameters of a machine learning model prior to deploying the machine learning model (e.g., through on-chip storage) to the XR device 710 for inference, memory footprint may be reduced while still ensuring accurate or high-performing inference. This may also result in improved battery life or lower latency. The XR device 710 can, for example, apply such machine learning models in the processing of image data or audio data.

In some examples, the server 712 may be used to perform certain detection and tracking based on sensor data (e.g., image and depth data) from the XR device 710. Accordingly, the XR device 710 or the server 712, or both, can perform image processing, object detection and/or object tracking functions based on images captured by the XR device 710 and one or more parameters internal or external to the XR device 710. In some examples, the server 712 may include or be coupled to a processing system such as the processing system 600 of FIG. 6.

The network 704 may be any network that enables communication between or among machines (e.g., server 712), databases, and devices (e.g., XR device 710). Accordingly, the network 704 may be a wired network, a wireless network (e.g., a mobile or cellular network), or any suitable combination thereof. The network 704 may include one or more portions that constitute a private network, a public network (e.g., the Internet), or any suitable combination thereof.

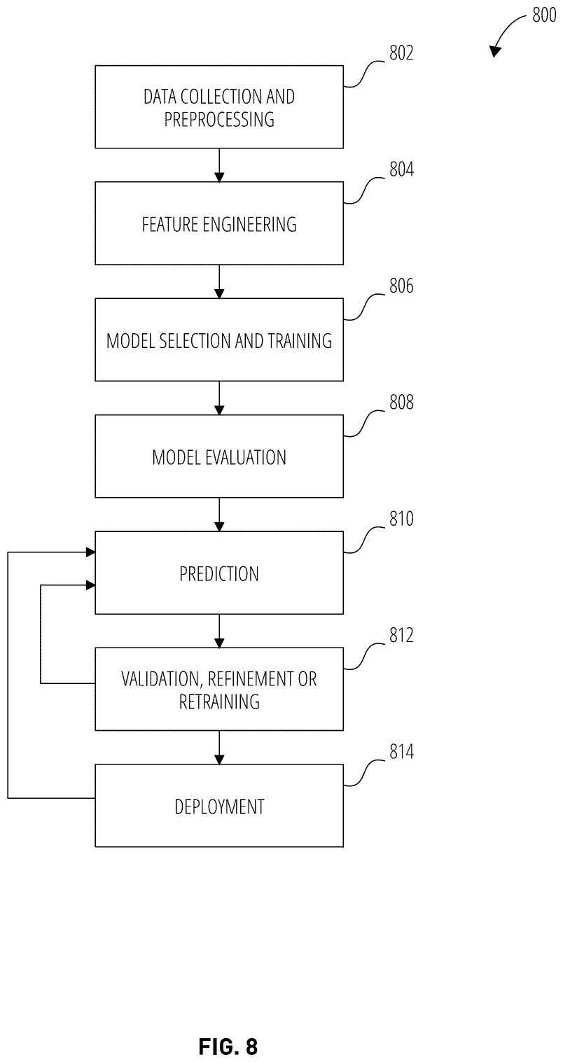

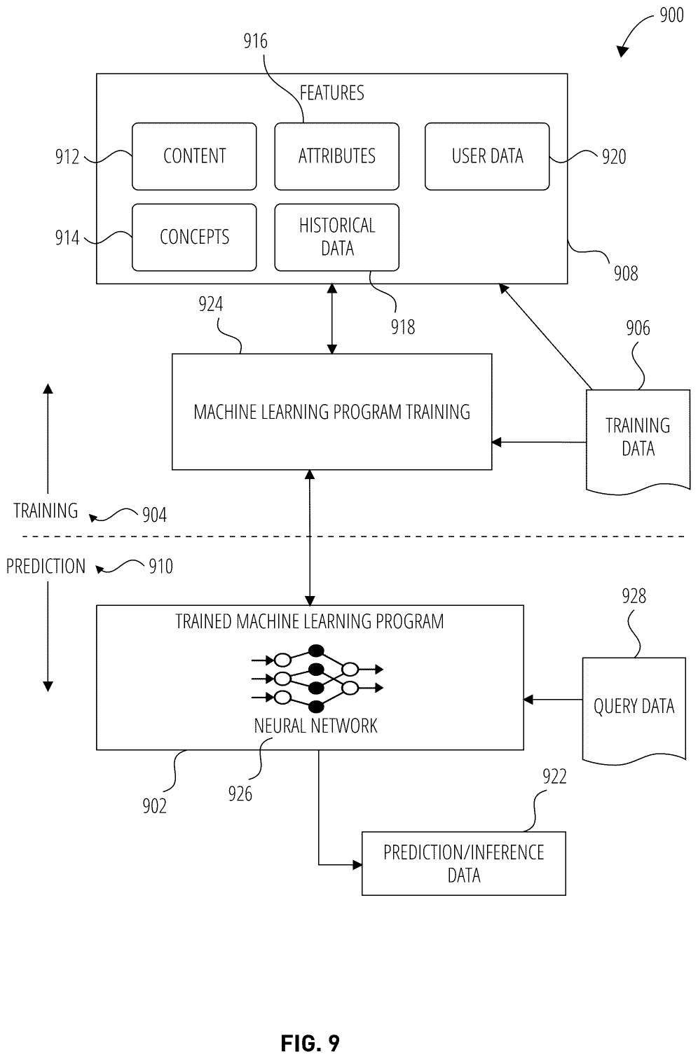

FIG. 8 is a flowchart depicting a machine learning pipeline 800, according to some examples. The machine learning pipeline 800 may be used to generate a trained model, for example, the trained machine learning program 902 shown in the diagram 900 of FIG. 9.

Broadly, machine learning may involve using computer algorithms to automatically learn patterns and relationships in data, potentially without the need for explicit programming. Machine learning algorithms may be divided into three main categories: supervised learning, unsupervised learning, and reinforcement learning.
Supervised learning involves training a model using labeled data to predict an output for new, unseen inputs. Examples of supervised learning algorithms may include linear regression, decision trees, and neural networks.
Unsupervised learning involves training a model on unlabeled data to find hidden patterns and relationships in the data. Examples of unsupervised learning algorithms may include clustering, principal component analysis, and generative models, such as autoencoders.
Reinforcement learning involves training a model to make decisions in a dynamic environment by receiving feedback in the form of rewards or penalties. Examples of reinforcement learning algorithms may include Q-learning and policy gradient methods.

Examples of specific machine learning algorithms that may be deployed, according to some examples, include logistic regression, which is a type of supervised learning algorithm used for binary classification tasks. Logistic regression models the probability of a binary response variable based on one or more predictor variables. Another example type of machine learning algorithm is Naïve Bayes, which is a supervised learning algorithm used for classification tasks. Naïve Bayes is based on Bayes' theorem and assumes that the predictor variables are independent of each other. Random Forest is another type of supervised learning algorithm used for classification, regression, and other tasks. Random Forest builds a collection of decision trees and combines their outputs to make predictions. Further examples include neural networks, which consist of interconnected layers of nodes (or neurons) that process information and make predictions based on the input data. Matrix factorization is another type of machine learning algorithm used for recommender systems and other tasks. Matrix factorization decomposes a matrix into two or more matrices to uncover hidden patterns or relationships in the data. Support Vector Machines (SVM) are a type of supervised learning algorithm used for classification, regression, and other tasks. SVM finds a hyperplane that separates the different classes in the data. Other types of machine learning algorithms may include decision trees, k-nearest neighbors, clustering algorithms, and deep learning algorithms, such as CNNs, recurrent neural networks (RNNs), and transformer models. The choice of algorithm may depend on the nature of the data, the complexity of the problem, and the performance requirements of the application.

The performance of machine learning models may be evaluated on a separate test set of data that was not used during training to ensure that the model can generalize to new, unseen data. Deep learning algorithms such as convolutional neural networks, recurrent neural networks, and transformers, as well as more traditional machine learning algorithms like decision trees, random forests, and gradient boosting may be used in various machine learning applications.

Two example types of problems in machine learning are classification problems and regression problems. Classification problems, also referred to as categorization problems, aim at classifying items into one of several category values (for example, is this object an apple or an orange?). Regression algorithms aim at quantifying some items (for example, by providing a value that is a real number).

Generating a trained machine learning program 902 may include multiple phases that form part of the machine learning pipeline 800, including for example the following phases illustrated in FIG. 8:
Data collection and preprocessing 802: This phase may include acquiring and cleaning data to ensure that it is suitable for use in the machine learning model. This phase may also include removing duplicates, handling missing values, and converting data into a suitable format.
Feature engineering 804: This phase may include selecting and transforming the training data 906 to create features that are useful for predicting the target variable. Feature engineering may include (1) receiving features 908 (e.g., as structured or labeled data in supervised learning) and/or (2) identifying features 908 (e.g., unstructured or unlabeled data for unsupervised learning) in training data 906.
Model selection and training 806: This phase may include selecting an appropriate machine learning algorithm and training it on the preprocessed data. This phase may further involve splitting the data into training and testing sets, using cross-validation to evaluate the model, and tuning hyperparameters to improve performance.
Model evaluation 808: This phase may include evaluating the performance of a trained model (e.g., the trained machine learning program 902) on a separate testing dataset. This phase can help determine if the model is overfitting or underfitting and determine whether the model is suitable for deployment.
Prediction 810: This phase involves using a trained model (e.g., trained machine learning program 902) to generate predictions on new, unseen data.
Validation, refinement or retraining 812: This phase may include updating a model based on feedback generated from the prediction phase, such as new data or user feedback.
Deployment 814: This phase may include integrating the trained model (e.g., the trained machine learning program 902) into a more extensive system or application, such as a web service, mobile app, or Internet of Things (IoT) device. This phase can involve setting up APIs, building a user interface, and ensuring that the model is scalable and can handle large volumes of data.
In some examples, quantization may be performed prior to deployment 814. For example, the machine learning model may be processed through a quantization pipeline, such as the quantization pipeline 402 of FIG. 4, prior to deployment on target hardware.

FIG. 9 illustrates further details of two example phases, namely a training phase 904 (e.g., part of model selection and training 806) and a prediction phase 910 (part of prediction 810). Prior to the training phase 904, feature engineering 804 is used to identify features 908. This may include identifying informative, discriminating, and independent features for effectively operating the trained machine learning program 902 in pattern recognition, classification, and regression. In some examples, the training data 906 includes labeled data, known for pre-identified features 908 and one or more outcomes. Each of the features 908 may be a variable or attribute, such as an individual measurable property of a process, article, system, or phenomenon represented by a data set (e.g., the training data 906). Features 908 may also be of different types, such as numeric features, strings, and graphs, and may include one or more of content 912, concepts 914, attributes 916, historical data 918, and/or user data 920, merely for example.

In training phase 904, the machine learning program may use the training data 906 to find correlations among the features 908 that affect a predicted outcome or prediction/inference data 922. With the training data 906 and the identified features 908, the trained machine learning program 902 is trained during the training phase 904 during machine learning program training 924. The machine learning program training 924 appraises values of the features 908 as they correlate to the training data 906. The result of the training is the trained machine learning program 902 (e.g., a trained or learned model).

Further, the training phase 904 may involve machine learning, in which the training data 906 is structured (e.g., labeled during preprocessing operations). The trained machine learning program 902 may implement a neural network 926 capable of performing, for example, classification or clustering operations. In other examples, the training phase 904 may involve deep learning, in which the training data 906 is unstructured, and the trained machine learning program 902 implements a deep neural network 926 that can perform both feature extraction and classification/clustering operations.

In some examples, a neural network 926 may be generated during the training phase 904, and implemented within the trained machine learning program 902. The neural network 926 includes a hierarchical (e.g., layered) organization of neurons, with each layer consisting of multiple neurons or nodes. Neurons in the input layer receive the input data, while neurons in the output layer produce the final output of the network. Between the input and output layers, there may be one or more hidden layers, each consisting of multiple neurons.

Each neuron in the neural network 926 may operationally compute a function, such as an activation function, which takes as input the weighted sum of the outputs of the neurons in the previous layer, as well as a bias term. The output of this function is then passed as input to the neurons in the next layer. If the output of the activation function exceeds a certain threshold, an output is communicated from that neuron (e.g., transmitting neuron) to a connected neuron (e.g., receiving neuron) in successive layers. The connections between neurons have associated weights, which define the influence of the input from a transmitting neuron to a receiving neuron. During the training phase, these weights are adjusted by the learning algorithm to optimize the performance of the network. Different types of neural networks may use different activation functions and learning algorithms, affecting their performance on different tasks. The layered organization of neurons and the use of activation functions and weights enable neural networks to model complex relationships between inputs and outputs, and to generalize to new inputs that were not seen during training.

In some examples, the neural network 926 may also be one of several different types of neural networks, such as a single-layer feed-forward network, a Multilayer Perceptron (MLP), an Artificial Neural Network (ANN), a RNN, a Long Short-Term Memory Network (LSTM), a Bidirectional Neural Network, a symmetrically connected neural network, a Deep Belief Network (DBN), a CNN, a Generative Adversarial Network (GAN), an Autoencoder Neural Network (AE), a Restricted Boltzmann Machine (RBM), a Hopfield Network, a Self-Organizing Map (SOM), a Radial Basis Function Network (RBFN), a Spiking Neural Network (SNN), a Liquid State Machine (LSM), an Echo State Network (ESN), a Neural Turing Machine (NTM), or a Transformer Network, merely for example.

In addition to the training phase 904, a validation phase may be performed on a separate dataset known as the validation dataset. The validation dataset is used to tune the hyperparameters of a model, such as the learning rate and the regularization parameter. The hyperparameters are adjusted to improve the model's performance on the validation dataset.

Once a model is fully trained and validated, in a testing phase, the model may be tested on a new dataset. The testing dataset is used to evaluate the model's performance and ensure that the model has not overfitted the training data.

In the prediction phase 910, the trained machine learning program 902 uses the features 908 for analyzing query data 928 to generate inferences, outcomes, or predictions, as examples of a prediction/inference data 922. For example, during prediction phase 910, the trained machine learning program 902 generates an output. Query data 928 is provided as an input to the trained machine learning program 902, and the trained machine learning program 902 generates the prediction/inference data 922 as output, responsive to receipt of the query data 928.

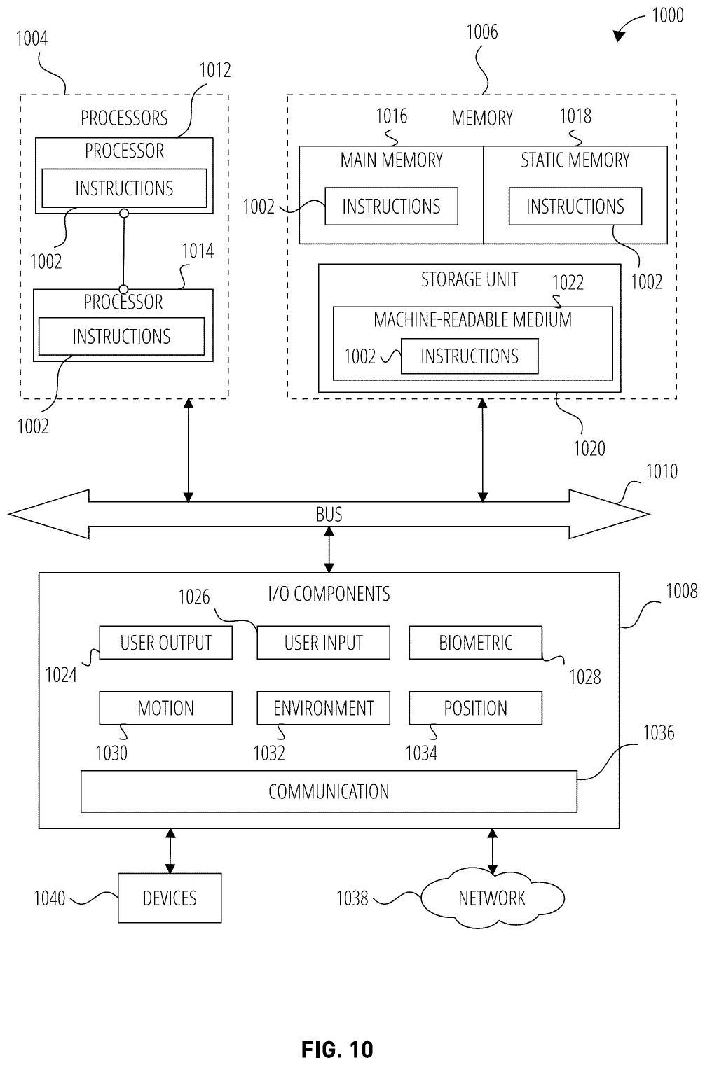

FIG. 10 is a diagrammatic representation of a machine 1000 within which instructions 1002 (e.g., software, a program, an application, an applet, an app, or other executable code) for causing the machine 1000 to perform any one or more of the methodologies discussed herein may be executed. For example, the instructions 1002 may cause the machine 1000 to execute any one or more of the methods described herein. The instructions 1002 transform the general, non-programmed machine 1000 into a particular machine 1000 programmed to carry out the described and illustrated functions in the manner described. The machine 1000 may operate as a standalone device or may be coupled (e.g., networked) to other machines. In a networked deployment, the machine 1000 may operate in the capacity of a server machine or a client machine in a server-client network environment, or as a peer machine in a peer-to-peer (or distributed) network environment. The machine 1000 may comprise, but not be limited to, a server computer, a client computer, a personal computer (PC), a tablet computer, a laptop computer, a netbook, a set-top box (STB), a personal digital assistant (PDA), an entertainment media system, a cellular telephone, a smartphone, a mobile device, a wearable device (e.g., a smartwatch), a smart home device (e.g., a smart appliance), other smart devices, a web appliance, a network router, a network switch, a network bridge, or any machine capable of executing the instructions 1002, sequentially or otherwise, that specify actions to be taken by the machine 1000. Further, while a single machine 1000 is illustrated, the term “machine” shall also be taken to include a collection of machines that individually or jointly execute the instructions 1002 to perform any one or more of the methodologies discussed herein. The machine 1000, for example, may comprise the user system 102 or any one of multiple server devices forming part of the server system 110. In some examples, the machine 1000 may also comprise both client and server systems, with certain operations of a particular method or algorithm being performed on the server-side and with certain operations of the particular method or algorithm being performed on the client-side.

The machine 1000 may include processors 1004, memory 1006, and input/output I/O components 1008, which may be configured to communicate with each other via a bus 1010. In an example, the processors 1004 may include, for example, a processor 1012 and a processor 1014 that execute the instructions 1002. Although FIG. 10 shows multiple processors 1004, the machine 1000 may include a single processor with a single-core, a single processor with multiple cores (e.g., a multi-core processor), multiple processors with a single core, multiple processors with multiples cores, or any combination thereof.

The memory 1006 includes a main memory 1016, a static memory 1018, and a storage unit 1020, both accessible to the processors 1004 via the bus 1010. The main memory 1006, the static memory 1018, and storage unit 1020 store the instructions 1002 embodying any one or more of the methodologies or functions described herein. The instructions 1002 may also reside, completely or partially, within the main memory 1016, within the static memory 1018, within machine-readable medium 1022 within the storage unit 1020, within at least one of the processors 1004 (e.g., within the processor's cache memory), or any suitable combination thereof, during execution thereof by the machine 1000.

The I/O components 1008 may include a wide variety of components to receive input, provide output, produce output, transmit information, exchange information, capture measurements, and so on. The specific I/O components 1008 that are included in a particular machine will depend on the type of machine. For example, portable machines such as mobile phones may include a touch input device or other such input mechanisms, while a headless server machine will likely not include such a touch input device. It will be appreciated that the I/O components 1008 may include many other components that are not shown in FIG. 10. In various examples, the I/O components 1008 may include user output components 1024 and user input components 1026. The user output components 1024 may include visual components (e.g., a display such as a plasma display panel (PDP), a light-emitting diode (LED) display, a liquid crystal display (LCD), a projector, or a cathode ray tube (CRT)), acoustic components (e.g., speakers), haptic components (e.g., a vibratory motor, resistance mechanisms), other signal generators, and so forth. The user input components 1026 may include alphanumeric input components (e.g., a keyboard, a touch screen configured to receive alphanumeric input, a photo-optical keyboard, or other alphanumeric input components), point-based input components (e.g., a mouse, a touchpad, a trackball, a joystick, a motion sensor, or another pointing instrument), tactile input components (e.g., a physical button, a touch screen that provides location and force of touches or touch gestures, or other tactile input components), audio input components (e.g., a microphone), and the like.

In further examples, the I/O components 1008 may include biometric components 1028, motion components 1030, environmental components 1032, or position components 1034, among a wide array of other components. For example, the biometric components 1028 include components to detect expressions (e.g., hand expressions, facial expressions, vocal expressions, body gestures, or eye-tracking), measure biosignals (e.g., blood pressure, heart rate, body temperature, perspiration, or brain waves), identify a person (e.g., voice identification, retinal identification, facial identification, fingerprint identification, or electroencephalogram-based identification), and the like.

Any biometric or other personally identifiable information (PII) collected by biometric or other data capturing components is captured and stored only with user approval and deleted on user request. Further, such data may be used for very limited purposes, such as identification verification. To ensure limited and authorized use of biometric and other PII, access to this data is restricted to authorized personnel only, if at all. The data is not shared or sold to any third party without the explicit consent of the user. In addition, appropriate technical and organizational measures are implemented to ensure the security and confidentiality of this sensitive information.

The motion components 1030 include acceleration sensor components (e.g., accelerometer), gravitation sensor components, rotation sensor components (e.g., gyroscope).

The environmental components 1032 include, for example, one or cameras (with still image/photograph and video capabilities), illumination sensor components (e.g., photometer), temperature sensor components (e.g., one or more thermometers that detect ambient temperature), humidity sensor components, pressure sensor components (e.g., barometer), acoustic sensor components (e.g., one or more microphones that detect background noise), proximity sensor components (e.g., infrared sensors that detect nearby objects), gas sensors (e.g., gas detection sensors to detection concentrations of hazardous gases for safety or to measure pollutants in the atmosphere), or other components that may provide indications, measurements, or signals corresponding to a surrounding physical environment.

With respect to cameras, the user system 102 may have a camera system comprising, for example, front cameras on a front surface of the user system 102 and rear cameras on a rear surface of the user system 102. The front cameras may, for example, be used to capture still images and video of a user of the user system 102 (e.g., “selfies”), which may then be augmented with augmentation data (e.g., filters) described above. The rear cameras may, for example, be used to capture still images and videos in a more traditional camera mode, with these images similarly being augmented with augmentation data. In addition to front and rear cameras, the user system 102 may also include a 360° camera for capturing 360° photographs and videos.

Further, the camera system of the user system 102 may include dual rear cameras (e.g., a primary camera as well as a depth-sensing camera), or even triple, quad or penta rear camera configurations on the front and rear sides of the user system 102. These multiple camera systems may include a wide camera, an ultra-wide camera, a telephoto camera, a macro camera, and a depth sensor, for example.

The position components 1034 include location sensor components (e.g., a GPS receiver component), altitude sensor components (e.g., altimeters or barometers that detect air pressure from which altitude may be derived), orientation sensor components (e.g., magnetometers), and the like.

Communication may be implemented using a wide variety of technologies. The I/O components 1008 further include communication components 1036 operable to couple the machine 1000 to a network 1038 or devices 1040 via respective coupling or connections. For example, the communication components 1036 may include a network interface component or another suitable device to interface with the network 1038. In further examples, the communication components 1036 may include wired communication components, wireless communication components, cellular communication components, Near Field Communication (NFC) components, Bluetooth™ components (e.g., Bluetooth™ Low Energy), Wi-Fi components, and other communication components to provide communication via other modalities. The devices 1040 may be another machine or any of a wide variety of peripheral devices (e.g., a peripheral device coupled via a USB).

Moreover, the communication components 1036 may detect identifiers or include components operable to detect identifiers. For example, the communication components 1036 may include Radio Frequency Identification (RFID) tag reader components, NFC smart tag detection components, optical reader components (e.g., an optical sensor to detect one-dimensional bar codes such as Universal Product Code (UPC) bar code, multi-dimensional bar codes such as Quick Response (QR) code, Aztec code, Data Matrix, Dataglyph™, MaxiCode, PDF417, Ultra Code, UCC RSS-2D bar code, and other optical codes), or acoustic detection components (e.g., microphones to identify tagged audio signals). In addition, a variety of information may be derived via the communication components 1036, such as location via Internet Protocol (IP) geolocation, location via Wi-Fi® signal triangulation, location via detecting an NFC beacon signal that may indicate a particular location, and so forth.

The various memories (e.g., main memory 1016, static memory 1018, and memory of the processors 1004) and storage unit 1020 may store one or more sets of instructions and data structures (e.g., software) embodying or used by any one or more of the methodologies or functions described herein. These instructions (e.g., the instructions 1002), when executed by processors 1004, cause various operations to implement the disclosed examples.

The instructions 1002 may be transmitted or received over the network 1038, using a transmission medium, via a network interface device (e.g., a network interface component included in the communication components 1036) and using any one of several well-known transfer protocols (e.g., hypertext transfer protocol (HTTP)). Similarly, the instructions 1002 may be transmitted or received using a transmission medium via a coupling (e.g., a peer-to-peer coupling) to the devices 1040.

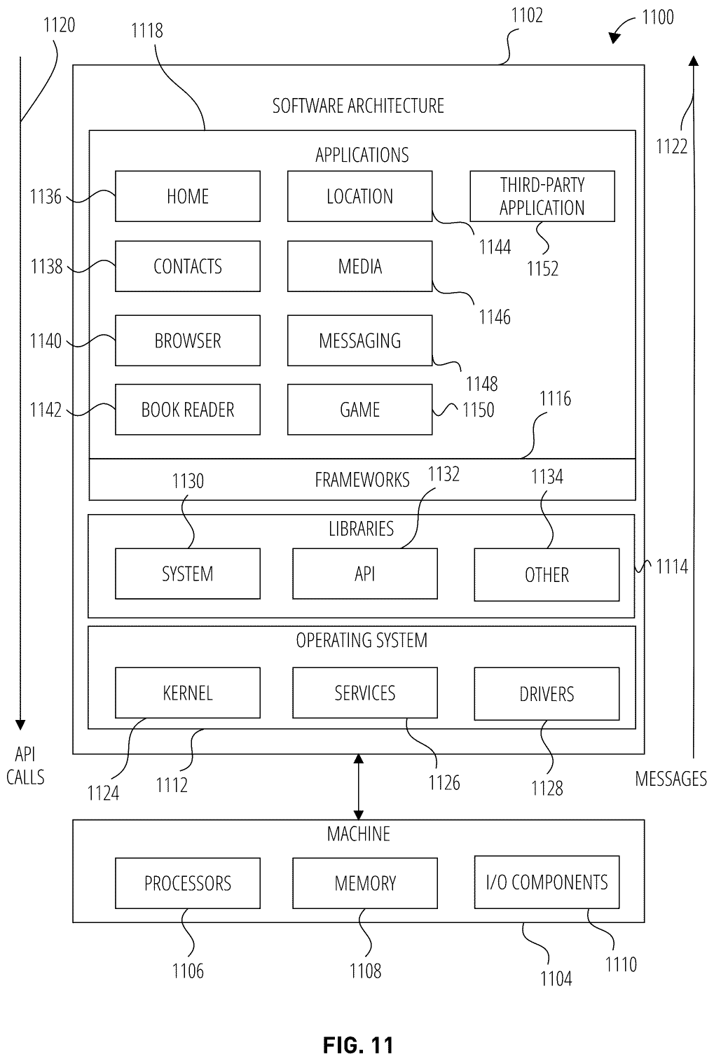

FIG. 11 is a block diagram 1100 illustrating a software architecture 1102, which can be installed on any one or more of the devices described herein. The software architecture 1102 is supported by hardware such as a machine 1104 that includes processors 1106, memory 1108, and I/O components 1110. In this example, the software architecture 1102 can be conceptualized as a stack of layers, where each layer provides a particular functionality. The software architecture 1102 includes layers such as an operating system 1112, libraries 1114, frameworks 1116, and applications 1118. Operationally, the applications 1118 invoke API calls 1120 through the software stack and receive messages 1122 in response to the API calls 1120.

The operating system 1112 manages hardware resources and provides common services. The operating system 1112 includes, for example, a kernel 1124, services 1126, and drivers 1128. The kernel 1124 acts as an abstraction layer between the hardware and the other software layers. For example, the kernel 1124 provides memory management, processor management (e.g., scheduling), component management, networking, and security settings, among other functionalities. The services 1126 can provide other common services for the other software layers. The drivers 1128 are responsible for controlling or interfacing with the underlying hardware. For instance, the drivers 1128 can include display drivers, camera drivers, Bluetooth™ or Bluetooth™ Low Energy drivers, flash memory drivers, serial communication drivers (e.g., USB drivers), WI-FI drivers, audio drivers, power management drivers, and so forth.

The libraries 1114 provide a common low-level infrastructure used by the applications 1118. The libraries 1114 can include system libraries 1130 (e.g., C standard library) that provide functions such as memory allocation functions, string manipulation functions, mathematic functions, and the like. In addition, the libraries 1114 can include API libraries 1132 such as media libraries (e.g., libraries to support presentation and manipulation of various media formats such as Moving Picture Experts Group-4 (MPEG4), Advanced Video Coding (H.264 or AVC), Moving Picture Experts Group Layer-3 (MP3), Advanced Audio Coding (AAC), Adaptive Multi-Rate (AMR) audio codec, Joint Photographic Experts Group (JPEG or JPG), or Portable Network Graphics (PNG)), graphics libraries (e.g., an OpenGL framework used to render in two dimensions (2D) and three dimensions (3D) in a graphic content on a display), database libraries (e.g., SQLite to provide various relational database functions), web libraries (e.g., WebKit to provide web browsing functionality), and the like. The libraries 1114 can also include a wide variety of other libraries 1134 to provide many other APIs to the applications 1118.

The frameworks 1116 provide a common high-level infrastructure that is used by the applications 1118. For example, the frameworks 1116 provide various graphical user interface (GUI) functions, high-level resource management, and high-level location services. The frameworks 1116 can provide a broad spectrum of other APIs that can be used by the applications 1118, some of which may be specific to a particular operating system or platform.

In an example, the applications 1118 may include a home application 1136, a contacts application 1138, a browser application 1140, a book reader application 1142, a location application 1144, a media application 1146, a messaging application 1148, a game application 1150, and a broad assortment of other applications such as a third-party application 1152. The applications 1118 are programs that execute functions defined in the programs. Various programming languages can be employed to create one or more of the applications 1118, structured in a variety of manners, such as object-oriented programming languages (e.g., Objective-C, Java, or C++) or procedural programming languages (e.g., C or assembly language). In a specific example, the third-party application 1152 (e.g., an application developed using the ANDROID™ or IOS™ SDK by an entity other than the vendor of the particular platform) may be mobile software running on a mobile operating system such as IOS™, ANDROID™, WINDOWS® Phone, or another mobile operating system. In this example, the third-party application 1152 can invoke the API calls 1120 provided by the operating system 1112 to facilitate functionalities described herein.

### EXAMPLES

In view of the above-described implementations of subject matter this application discloses the following list of examples, wherein one feature of an example in isolation or more than one feature of an example, taken in combination and, optionally, in combination with one or more features of one or more further examples are further examples also falling within the disclosure of this application.

Example 1 is a system comprising: at least one processor; and at least one memory storing instructions that, when executed by the at least one processor, cause the at least one processor to perform operations comprising: identifying a set of candidate quantization configurations for a component of a trained machine learning model; for each candidate quantization configuration in the set of candidate quantization configurations: applying the candidate quantization configuration to the component; after applying the candidate quantization configuration, executing the trained machine learning model on an input dataset to obtain candidate output values for the candidate quantization configuration, and determining a loss associated with the candidate quantization configuration based on a comparison between the candidate output values and reference output values for the component; selecting, for the component, a candidate quantization configuration from the set of candidate quantization configurations based on the determined losses associated with the set of candidate quantization configurations; and quantizing at least part of the trained machine learning model using the selected candidate quantization configuration for the component.

In Example 2, the subject matter of Example 1 includes, wherein the applying of the candidate quantization configuration to the component causes the trained machine learning model to be executed with the component having quantized parameters, and the reference output values are obtained by executing the trained machine learning model with the component having unquantized parameters.

In Example 3, the subject matter of any of Examples 1-2 includes, wherein the component is one of a plurality of components of the trained machine learning model, the selected candidate quantization configuration is a first quantization configuration, and the trained machine learning model is quantized using the first quantization configuration for the component and one or more further quantization configurations selected for one or more further components of the plurality of components.

In Example 4, the subject matter of Example 3 includes, wherein the trained machine learning model comprises a neural network, the plurality of components comprises a plurality of layers of the neural network, and, for each candidate quantization configuration, the candidate output values are candidate feature map values, the reference output values being reference feature map values for one of the plurality of layers.

In Example 5, the subject matter of Example 4 includes, wherein the first quantization configuration comprises first bit settings for quantizing parameters of a first layer of the plurality of layers, and the one or more further quantization configurations comprise second bit settings for quantizing parameters of one or more further layers of the neural network, the first bit settings being different than the second bit settings.

In Example 6, the subject matter of any of Examples 3-5 includes, wherein the trained machine learning model comprises a neural network, and the plurality of components comprises a plurality of channels within a layer of the neural network.

In Example 7, the subject matter of any of Examples 1-6 includes, wherein the set of candidate quantization configurations is a first set, the component of the trained machine learning model is a first component, the candidate output values are first candidate output values, the reference output values are first reference output values, and the selected candidate quantization configuration is a first candidate quantization configuration, the operations further comprising: identifying a second set of candidate quantization configurations for a second component of the trained machine learning model; for each candidate quantization configuration in the second set of candidate quantization configurations, determining the loss associated with the candidate quantization configuration based on a comparison between second candidate output values and second reference output values for the second component, the second candidate output values obtained by applying the candidate quantization configuration to the second component prior to execution of the trained machine learning model; and selecting, for the second component, a second candidate quantization configuration from the second set of candidate quantization configurations based on the determined losses associated with the second set of candidate quantization configurations, wherein the trained machine learning model is quantized using the first candidate quantization configuration for the first component and the second candidate quantization configuration for the second component.

In Example 8, the subject matter of any of Examples 1-7 includes, wherein the component comprises a layer of a neural network, the layer is associated with a threshold function, and the threshold function is applied to obtain at least a subset of the candidate output values and at least a subset of the reference output values.

In Example 9, the subject matter of any of Examples 1-8 includes, wherein each candidate quantization configuration in the set of candidate quantization configurations comprises bit settings for quantizing parameters of the component of the trained machine learning model.

In Example 10, the subject matter of Example 9 includes, wherein the parameters comprise weights, and each weight is quantized to be represented by a combination of exponent bits and mantissa bits.

In Example 11, the subject matter of any of Examples 1-10 includes, the operations further comprising: receiving, from a user device, a quantization request comprising a selected bit precision for quantization of the component, wherein the set of candidate quantization configurations is identified based on the selected bit precision, the set of candidate quantization configurations comprising different combinations of exponent bits and mantissa bits that satisfy the selected bit precision.

In Example 12, the subject matter of any of Examples 1-11 includes, wherein the loss is determined based on a loss function, and the selecting of the candidate quantization configuration from the set of candidate quantization configurations comprises: detecting that the selected candidate quantization configuration results in a lowest value for the loss function with respect to the component of the trained machine learning model.

In Example 13, the subject matter of any of Examples 1-12 includes, wherein the quantizing of the trained machine learning model comprises quantizing parameters of the trained machine learning model, the operations further comprising: storing the quantized parameters in on-chip memory of a processing device.

In Example 14, the subject matter of any of Examples 1-13 includes, wherein the trained machine learning model comprises a neural network, and the operations further comprise: performing batch normalization folding prior to obtaining the reference output values and prior to the quantization of the trained machine learning model.

In Example 15, the subject matter of any of Examples 1-14 includes, the operations further comprising: generating output comprising the selected candidate quantization configuration; and causing the output to be transmitted to a user device.

In Example 16, the subject matter of any of Examples 1-15 includes, wherein the quantization of the trained machine learning model comprises generating a new instance of the trained machine learning model that comprises the selected candidate quantization configuration for the component, the operations further comprising: receiving, from a user device, a quantization request; and generating, in response to receiving the quantization request, the new instance of the trained machine learning model.

In Example 17, the subject matter of any of Examples 1-16 includes, wherein the input dataset comprises unlabeled sample data.

In Example 18, the subject matter of any of Examples 1-17 includes, wherein the input dataset comprises unlabeled sample images.

Example 19 is a method comprising: identifying a set of candidate quantization configurations for a component of a trained machine learning model; for each candidate quantization configuration in the set of candidate quantization configurations: applying the candidate quantization configuration to the component; after applying the candidate quantization configuration, executing the trained machine learning model on an input dataset to obtain candidate output values for the candidate quantization configuration, and determining a loss associated with the candidate quantization configuration based on a comparison between the candidate output values and reference output values for the component; selecting, for the component, a candidate quantization configuration from the set of candidate quantization configurations based on the determined losses associated with the set of candidate quantization configurations; and quantizing at least part of the trained machine learning model using the selected candidate quantization configuration for the component.

Example 20 is a non-transitory computer-readable storage medium storing instructions that, when executed by at least one processor, cause the at least one processor to perform operations comprising: identifying a set of candidate quantization configurations for a component of a trained machine learning model; for each candidate quantization configuration in the set of candidate quantization configurations: applying the candidate quantization configuration to the component; after applying the candidate quantization configuration, executing the trained machine learning model on an input dataset to obtain candidate output values for candidate quantization configuration, and determining a loss associated with the candidate quantization configuration based on a comparison between the candidate output values and reference output values for the component; selecting, for the component, a candidate quantization configuration from the set of candidate quantization configurations based on the determined losses associated with the set of candidate quantization configurations; and quantizing at least part of the trained machine learning model using the selected candidate quantization configuration for the component.

Example 21 is at least one machine-readable medium including instructions that, when executed by processing circuitry, cause the processing circuitry to perform operations to implement any of Examples 1-20.

Example 22 is an apparatus comprising means to implement any of Examples 1-20.

Example 23 is a system to implement any of Examples 1-20.

Example 24 is a method to implement any of Examples 1-20.

### CONCLUSION

Although specific examples are described herein, it will be evident that various modifications and changes may be made to these examples without departing from the broader spirit or scope of the disclosure. Accordingly, the specification and drawings are to be regarded in an illustrative rather than a restrictive sense. The accompanying drawings that form a part hereof show by way of illustration, and not of limitation, specific examples in which the subject matter may be practiced. The examples illustrated are described in sufficient detail to enable those skilled in the art to practice the teachings disclosed herein. Other examples may be utilized and derived therefrom, such that structural and logical substitutions and changes may be made without departing from the scope of this disclosure. This detailed description, therefore, is not to be taken in a limiting sense, and the scope of various examples is defined only by the appended claims, along with the full range of equivalents to which such claims are entitled.

Such examples of the subject matter may be referred to herein, individually or collectively, by the term “example” or merely for convenience and without intending to voluntarily limit the scope of this application to any single example or concept if more than one is in fact disclosed. Thus, although specific examples have been illustrated and described herein, it should be appreciated that another arrangement calculated to achieve the same purpose may be substituted for the specific examples shown. This disclosure is intended to cover any and all adaptations or variations of various examples. Combinations of the above examples, and other examples not specifically described herein, will be apparent to those of skill in the art upon reviewing the above description.

As used in this disclosure, the term “machine learning model” (or simply “model”) may refer to a single, standalone model, or a combination of models. The term may also refer to a system, component or module that includes a machine learning model together with one or more supporting or supplementary components that do not necessarily perform machine learning tasks.

Some portions of the subject matter discussed herein may be presented in terms of algorithms or symbolic representations of operations on data stored as bits or binary digital signals within a machine memory (e.g., a computer memory). Such algorithms or symbolic representations are examples of techniques used by those of ordinary skill in the data processing arts to convey the substance of their work to others skilled in the art. As used herein, an “algorithm” is a self-consistent sequence of operations or similar processing leading to a desired result. In this context, algorithms and operations involve physical manipulation of physical quantities. Typically, but not necessarily, such quantities may take the form of electrical, magnetic, or optical signals capable of being stored, accessed, transferred, combined, compared, or otherwise manipulated by a machine. It is convenient at times, principally for reasons of common usage, to refer to such signals using words such as “data,” “content,” “bits,” “values,” “elements,” “symbols,” “characters,” “terms,” “numbers,” “numerals,” or the like. These words, however, are merely convenient labels and are to be associated with appropriate physical quantities.

Unless specifically stated otherwise, discussions herein using words such as “processing,” “computing,” “calculating,” “determining,” “presenting,” “displaying,” or the like may refer to actions or processes of a machine (e.g., a computer) that manipulates or transforms data represented as physical (e.g., electronic, magnetic, or optical) quantities within one or more memories (e.g., volatile memory, non-volatile memory, or any suitable combination thereof), registers, or other machine components that receive, store, transmit, or display information. Furthermore, unless specifically stated otherwise, the terms “a” and “an” are herein used, as is common in patent documents, to include one or more than one instance.

As used in this disclosure, phrases of the form “at least one of an A, a B, or a C,” “at least one of A, B, or C,” “at least one of A, B, and C,” and the like, should be interpreted to select at least one from the group that comprises “A, B, and C.” Unless explicitly stated otherwise in connection with a particular instance in this disclosure, this manner of phrasing does not mean “at least one of A, at least one of B, and at least one of C.” As used in this disclosure, the example “at least one of an A, a B, or a C,” would cover any of the following selections: {A}, {B}, {C}, {A, B}, {A, C}, {B, C}, and {A, B, C}.

Unless the context clearly requires otherwise, throughout the description and the claims, the words “comprise,” “comprising,” and the like are to be construed in an inclusive sense, as opposed to an exclusive or exhaustive sense, e.g., in the sense of “including, but not limited to.” As used herein, the terms “connected,” “coupled,” or any variant thereof means any connection or coupling, either direct or indirect, between two or more elements; the coupling or connection between the elements can be physical, logical, or a combination thereof. Additionally, the words “herein,” “above,” “below,” and words of similar import, when used in this application, refer to this application as a whole and not to any particular portions of this application. Where the context permits, words using the singular or plural number may also include the plural or singular number, respectively. The word “or” in reference to a list of two or more items, covers all of the following interpretations of the word: any one of the items in the list, all of the items in the list, and any combination of the items in the list. Likewise, the term “and/or” in reference to a list of two or more items, covers all of the following interpretations of the word: any one of the items in the list, all of the items in the list, and any combination of the items in the list.

The various features, steps, operations, and processes described herein may be used independently of one another, or may be combined in various ways. All possible combinations and subcombinations are intended to fall within the scope of this disclosure. In addition, certain method or process blocks or operations may be omitted in some implementations.

Although some examples (e.g., those depicted in the drawings) include a particular sequence of operations, the sequence may be altered without departing from the scope of the present disclosure. For example, some of the operations depicted may be performed in parallel or in a different sequence that does not materially affect the functions as described in the examples. In other examples, different components of an example device or system that implements an example method may perform functions at substantially the same time or in a specific sequence.

### Glossary

“Carrier signal” refers, for example, to any intangible medium that is capable of storing, encoding, or carrying instructions for execution by the machine and includes digital or analog communications signals or other intangible media to facilitate communication of such instructions. Instructions may be transmitted or received over a network using a transmission medium via a network interface device.

“Client device” refers, for example, to any machine that interfaces to a communications network to obtain resources from one or more server systems or other client devices. A client device may be, but is not limited to, a mobile phone, desktop computer, laptop, portable digital assistant (PDA), smartphone, tablet, ultrabook, netbook, laptop, multi-processor system, microprocessor-based or programmable consumer electronics, game console, set-top box, or any other communication device that a user may use to access a network.

“Communication network” refers, for example, to one or more portions of a network that may be an ad hoc network, an intranet, an extranet, a virtual private network (VPN), a local area network (LAN), a wireless LAN (WLAN), a wide area network (WAN), a wireless WAN (WWAN), a metropolitan area network (MAN), the Internet, a portion of the Internet, a portion of the Public Switched Telephone Network (PSTN), a plain old telephone service (POTS) network, a cellular telephone network, a wireless network, a Wi-Fi® network, another type of network, or a combination of two or more such networks. For example, a network or a portion of a network may include a wireless or cellular network, and the coupling may be a Code Division Multiple Access (CDMA) connection, a Global System for Mobile communications (GSM) connection, or other types of cellular or wireless coupling. In this example, the coupling may implement any of a variety of types of data transfer technology, such as Single Carrier Radio Transmission Technology (1×RTT), Evolution-Data Optimized (EVDO) technology, General Packet Radio Service (GPRS) technology, Enhanced Data rates for GSM Evolution (EDGE) technology, third Generation Partnership Project (3GPP) including 3G, fourth-generation wireless (4G) networks, Universal Mobile Telecommunications System (UMTS), High Speed Packet Access (HSPA), Worldwide Interoperability for Microwave Access (WiMAX), Long Term Evolution (LTE) standard, others defined by various standard-setting organizations, other long-range protocols, or other data transfer technology.

“Component” refers, for example, to a device, physical entity, or logic having boundaries defined by function or subroutine calls, branch points, Application Programming Interfaces (APIs), or other technologies that provide for the partitioning or modularization of particular processing or control functions. Components may be combined via their interfaces with other components to carry out a machine process. A component may be a packaged functional hardware unit designed for use with other components and a part of a program that usually performs a particular function of related functions. Components may constitute either software components (e.g., code embodied on a machine-readable medium) or hardware components. A “hardware component” is a tangible unit capable of performing certain operations and may be configured or arranged in a certain physical manner. In various examples, one or more computer systems (e.g., a standalone computer system, a client computer system, or a server computer system) or one or more hardware components of a computer system (e.g., a processor, a group of processors or part of a processor) may be configured by software (e.g., an application or application portion) as a hardware component that operates to perform certain operations as described herein. A hardware component may also be implemented mechanically, electronically, or any suitable combination thereof. For example, a hardware component may include dedicated circuitry or logic that is permanently configured to perform certain operations. A hardware component may be a special-purpose processor, such as a field-programmable gate array (FPGA) or an application-specific integrated circuit (ASIC). A hardware component may also include programmable logic or circuitry that is temporarily configured by software to perform certain operations. For example, a hardware component may include software executed by a general-purpose processor or other programmable processors. Once configured by such software, hardware components become specific machines (or specific components of a machine) uniquely tailored to perform the configured functions and are no longer general-purpose processors. It will be appreciated that the decision to implement a hardware component mechanically, in dedicated and permanently configured circuitry, or in temporarily configured circuitry (e.g., configured by software), may be driven by cost and time considerations. Accordingly, the phrase “hardware component” (or “hardware-implemented component”) should be understood to encompass a tangible entity, be that an entity that is physically constructed, permanently configured (e.g., hardwired), or temporarily configured (e.g., programmed) to operate in a certain manner or to perform certain operations described herein. Considering examples in which hardware components are temporarily configured (e.g., programmed), each of the hardware components need not be configured or instantiated at any one instance in time. For example, where a hardware component comprises a general-purpose processor configured by software to become a special-purpose processor, the general-purpose processor may be configured as respectively different special-purpose processors (e.g., comprising different hardware components) at different times. Software accordingly configures a particular processor or processors, for example, to constitute a particular hardware component at one instance of time and to constitute a different hardware component at a different instance of time. Hardware components can provide information to, and receive information from, other hardware components. Accordingly, the described hardware components may be regarded as being communicatively coupled. Where multiple hardware components exist contemporaneously, communications may be achieved through signal transmission (e.g., over appropriate circuits and buses) between or among two or more of the hardware components. In examples in which multiple hardware components are configured or instantiated at different times, communications between such hardware components may be achieved, for example, through the storage and retrieval of information in memory structures to which the multiple hardware components have access. For example, one hardware component may perform an operation and store the output of that operation in a memory device to which it is communicatively coupled. A further hardware component may then, at a later time, access the memory device to retrieve and process the stored output. Hardware components may also initiate communications with input or output devices, and can operate on a resource (e.g., a collection of information). The various operations of example methods described herein may be performed, at least partially, by one or more processors that are temporarily configured (e.g., by software) or permanently configured to perform the relevant operations. Whether temporarily or permanently configured, such processors may constitute processor-implemented components that operate to perform one or more operations or functions described herein. As used herein, “processor-implemented component” refers to a hardware component implemented using one or more processors. Similarly, the methods described herein may be at least partially processor-implemented, with a particular processor or processors (or part thereof) being an example of hardware. For example, at least some of the operations of a method may be performed by one or more processors or processor-implemented components. At least some of the operations may be performed by a group of computers (as examples of machines including processors), with these operations being accessible via a network (e.g., the Internet) and via one or more appropriate interfaces (e.g., an API). The performance of certain of the operations may be distributed among the processors, not only residing within a single machine, but deployed across a number of machines. In some examples, the processors or processor-implemented components may be located in a single geographic location (e.g., within a home environment, an office environment, or a server farm). In other examples, the processors or processor-implemented components may be distributed across a number of geographic locations.

“Computer-readable storage medium” refers, for example, to both machine-storage media and transmission media. Thus, the terms include both storage devices/media and carrier waves/modulated data signals. The terms “machine-readable medium,” “computer-readable medium” and “device-readable medium” mean the same thing and may be used interchangeably in this disclosure.

“Machine storage medium” refers, for example, to a single or multiple storage devices and media (e.g., a centralized or distributed database, and associated caches and servers) that store executable instructions, routines, and data. The term shall accordingly be taken to include, but not be limited to, solid-state memories, and optical and magnetic media, including memory internal or external to processors. Specific examples of machine-storage media, computer-storage media and device-storage media include non-volatile memory, including by way of example semiconductor memory devices, e.g., erasable programmable read-only memory (EPROM), electrically erasable programmable read-only memory (EEPROM), FPGA, and flash memory devices; magnetic disks such as internal hard disks and removable disks; magneto-optical disks; and CD-ROM and DVD-ROM disks. The terms “machine-storage media,” “computer-storage media,” and “device-storage media” specifically exclude carrier waves, modulated data signals, and other such media, at least some of which are covered under the term “signal medium.”

“Non-transitory computer-readable storage medium” refers, for example, to a tangible medium that is capable of storing, encoding, or carrying the instructions for execution by a machine.

“Processor” may refer to any one or more circuits or virtual circuits (e.g., a physical circuit emulated by logic executing on an actual processor) that manipulates data values according to control signals (e.g., commands, opcodes, machine code, control words, macroinstructions, etc.) and which produces corresponding output signals that are applied to operate a machine. A processor may, for example, include at least one of a CPU, a Reduced Instruction Set Computing (RISC) Processor, a Complex Instruction Set Computing (CISC) Processor, a GPU, a Digital Signal Processor (DSP), a Tensor Processing Unit (TPU), a Neural Processing Unit (NPU), a Vision Processing Unit (VPU), a Machine Learning Accelerator, an Artificial Intelligence Accelerator, an Application Specific Integrated Circuit (ASIC), a Field Programmable Gate Array (FPGA), a Radio-Frequency Integrated Circuit (RFIC), a Neuromorphic Processor, a Quantum Processor, or any combination thereof. A processor may be a multi-core processor having two or more independent processors (sometimes referred to as “cores”) that may execute instructions contemporaneously. Multi-core processors may contain multiple computational cores on a single integrated circuit die, each of which can independently execute program instructions in parallel. Parallel processing on multi-core processors may be implemented via architectures like superscalar, VLIW, vector processing, or SIMD that allow each core to run separate instruction streams concurrently. A processor may be emulated in software, running on a physical processor, as a virtual processor or virtual circuit. The virtual processor may behave like an independent processor but is implemented in software rather than hardware. Accordingly, unless a specific processor architecture, hardware, design, and/or structure is specified or is clear from the context, the term “processor,” “processing system,” or the like, should be interpreted broadly herein.

“Signal medium” refers, for example, to any intangible medium that is capable of storing, encoding, or carrying the instructions for execution by a machine and includes digital or analog communications signals or other intangible media to facilitate communication of software or data. The term “signal medium” shall be taken to include any form of a modulated data signal, carrier wave, and so forth. The term “modulated data signal” means a signal that has one or more of its characteristics set or changed in such a manner as to encode information in the signal. The terms “transmission medium” and “signal medium” mean the same thing and may be used interchangeably in this disclosure.

“User device” refers, for example, to a device accessed, controlled, or owned by a user and with which the user interacts to perform an action, or interaction on the user device, including an interaction with other users or computer systems. A user device may, for example, be one or more of the client devices listed above.

What is claimed is:

1. A system comprising:
at least one processor; and
at least one memory storing instructions that, when executed by the at least one processor, cause the at least one processor to perform operations comprising:
identifying a set of candidate quantization configurations for a component of a trained machine learning model;
for each candidate quantization configuration in the set of candidate quantization configurations:
applying the candidate quantization configuration to the component,
after applying the candidate quantization configuration, executing the trained machine learning model on an input dataset to obtain candidate output values for the candidate quantization configuration, and
determining a loss associated with the candidate quantization configuration based on a comparison between the candidate output values and reference output values for the component;
selecting, for the component, a candidate quantization configuration from the set of candidate quantization configurations based on the determined losses associated with the set of candidate quantization configurations; and
quantizing at least part of the trained machine learning model using the selected candidate quantization configuration for the component.

2. The system of claim 1, wherein the applying of the candidate quantization configuration to the component causes the trained machine learning model to be executed with the component having quantized parameters, and the reference output values are obtained by executing the trained machine learning model with the component having unquantized parameters.

3. The system of claim 1, wherein the component is one of a plurality of components of the trained machine learning model, the selected candidate quantization configuration is a first quantization configuration, and the trained machine learning model is quantized using the first quantization configuration for the component and one or more further quantization configurations selected for one or more further components of the plurality of components.

4. The system of claim 3, wherein the trained machine learning model comprises a neural network, the plurality of components comprises a plurality of layers of the neural network, and, for each candidate quantization configuration, the candidate output values are candidate feature map values, the reference output values being reference feature map values for one of the plurality of layers.

5. The system of claim 4, wherein the first quantization configuration comprises first bit settings for quantizing parameters of a first layer of the plurality of layers, and the one or more further quantization configurations comprise second bit settings for quantizing parameters of one or more further layers of the neural network, the first bit settings being different than the second bit settings.

6. The system of claim 3, wherein the trained machine learning model comprises a neural network, and the plurality of components comprises a plurality of channels within a layer of the neural network.

7. The system of claim 1, wherein the set of candidate quantization configurations is a first set, the component of the trained machine learning model is a first component, the candidate output values are first candidate output values, the reference output values are first reference output values, and the selected candidate quantization configuration is a first candidate quantization configuration, the operations further comprising:
identifying a second set of candidate quantization configurations for a second component of the trained machine learning model;
for each candidate quantization configuration in the second set of candidate quantization configurations, determining the loss associated with the candidate quantization configuration based on a comparison between second candidate output values and second reference output values for the second component, the second candidate output values obtained by applying the candidate quantization configuration to the second component prior to execution of the trained machine learning model; and
selecting, for the second component, a second candidate quantization configuration from the second set of candidate quantization configurations based on the determined losses associated with the second set of candidate quantization configurations,
wherein the trained machine learning model is quantized using the first candidate quantization configuration for the first component and the second candidate quantization configuration for the second component.

8. The system of claim 1, wherein the component comprises a layer of a neural network, the layer is associated with a threshold function, and the threshold function is applied to obtain at least a subset of the candidate output values and at least a subset of the reference output values.

9. The system of claim 1, wherein each candidate quantization configuration in the set of candidate quantization configurations comprises bit settings for quantizing parameters of the component of the trained machine learning model.

10. The system of claim 9, wherein the parameters comprise weights, and each weight is quantized to be represented by a combination of exponent bits and mantissa bits.

11. The system of claim 1, the operations further comprising:
receiving, from a user device, a quantization request comprising a selected bit precision for quantization of the component, wherein the set of candidate quantization configurations is identified based on the selected bit precision, the set of candidate quantization configurations comprising different combinations of exponent bits and mantissa bits that satisfy the selected bit precision.

12. The system of claim 1, wherein the loss is determined based on a loss function, and the selecting of the candidate quantization configuration from the set of candidate quantization configurations comprises:
detecting that the selected candidate quantization configuration results in a lowest value for the loss function with respect to the component of the trained machine learning model.

13. The system of claim 1, wherein the quantizing of the trained machine learning model comprises quantizing parameters of the trained machine learning model, the operations further comprising:
storing the quantized parameters in on-chip memory of a processing device.

14. The system of claim 1, wherein the trained machine learning model comprises a neural network, and the operations further comprise:
performing batch normalization folding prior to obtaining the reference output values and prior to the quantization of the trained machine learning model.

15. The system of claim 1, the operations further comprising:
generating output comprising the selected candidate quantization configuration; and
causing the output to be transmitted to a user device.

16. The system of claim 1, wherein the quantization of the trained machine learning model comprises generating a new instance of the trained machine learning model that comprises the selected candidate quantization configuration for the component, the operations further comprising:
receiving, from a user device, a quantization request; and
generating, in response to receiving the quantization request, the new instance of the trained machine learning model.

17. The system of claim 1, wherein the input dataset comprises unlabeled sample data.

18. The system of claim 1, wherein the input dataset comprises unlabeled sample images.

19. A method comprising:
identifying a set of candidate quantization configurations for a component of a trained machine learning model;
for each candidate quantization configuration in the set of candidate quantization configurations:
applying the candidate quantization configuration to the component,
after applying the candidate quantization configuration, executing the trained machine learning model on an input dataset to obtain candidate output values for the candidate quantization configuration, and
determining a loss associated with the candidate quantization configuration based on a comparison between the candidate output values and reference output values for the component;
selecting, for the component, a candidate quantization configuration from the set of candidate quantization configurations based on the determined losses associated with the set of candidate quantization configurations; and
quantizing at least part of the trained machine learning model using the selected candidate quantization configuration for the component.

20. A non-transitory computer-readable storage medium storing instructions that, when executed by at least one processor, cause the at least one processor to perform operations comprising:
identifying a set of candidate quantization configurations for a component of a trained machine learning model;
for each candidate quantization configuration in the set of candidate quantization configurations:
applying the candidate quantization configuration to the component,
after applying the candidate quantization configuration, executing the trained machine learning model on an input dataset to obtain candidate output values for candidate quantization configuration, and
determining a loss associated with the candidate quantization configuration based on a comparison between the candidate output values and reference output values for the component;
selecting, for the component, a candidate quantization configuration from the set of candidate quantization configurations based on the determined losses associated with the set of candidate quantization configurations; and
quantizing at least part of the trained machine learning model using the selected candidate quantization configuration for the component.
